(19) United States
(12) Patent Application Publication
(10) Pub. No.: US 2026/0193792 A1
(43) Pub. Date: Jul. 9, 2026

(54) BIOELECTRICAL PROCESS CONTROL AND METHODS OF USE THEREOF

(71) Applicant: ELECTRO-ACTIVE TECHNOLOGIES, INC., Knoxville, TN (US)

(72) Inventors: ABHIJEET P. BOROLE, Knoxville, TN (US); JORDAN WAYNE BREWER, Knoxville, TN (US); ALEX JAMES LEWIS

(21) Appl. No.: 18/284,433

(22) PCT Filed: Mar. 31, 2022
(86) PCT No.: PCT/US2022/022872

§ 371 Date: Sep. 27, 2023

Related U.S. Application Data
(60) Provisional application No. 63/168,818, filed on Mar. 31, 2021.

(51) Int. Cl. C25B 9/19; C25B 1/02; C25B 9/13; C25B 11/031; C25B 11/051; C25B 15/029; C25B 15/08; H01M 8/0656; H01M 8/16

(52) U.S. Cl. CPC C25B 9/19; C25B 1/02; C25B 9/13; C25B 11/031; C25B 11/051; C25B 15/029; C25B 15/08; H01M 8/0656; H01M 8/16

(57) ABSTRACT

This invention is directed to the control of processes for stable, high performance of bioelectrochemical systems. disclosed are methods for preparing bioelectrochemical systems (BESs), including establishing a biofilm while actively controlling and maintaining a cell voltage. Also disclosed are methods and systems for active, ongoing manual or automated control of BESs by removing excess biofilm, and measuring the presence of same.

### CROSS-REFERENCE TO RELATED APPLICATIONS

This application claims the benefit of priority to U.S. Patent Application No. 63/168,818, filed on Mar. 31, 2021, the entirety of which is incorporated herein by reference.

All patents, patent applications and publications cited herein are hereby incorporated by reference in their entirety. The disclosures of these publications in their entirety are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### GOVERNMENT INTERESTS

N/A

### FIELD OF THE INVENTION

This invention is directed to the control of processes for stable, high performance of bioelectrochemical systems.

### BACKGROUND OF THE INVENTION

Bioelectrochemical systems (BESs) (Borole, A. P. in Bioelectrochemical Biorefining in Biofuels & Bioenergy (ed. O. Konur) (CRC Press, 2017)) are devices which comprise an anode and a cathode that exchange electrons with ions or chemical molecules via redox reactions, producing electricity or new chemical/s and employ biological and electrochemical catalysts to facilitate the reactions. Two exemplary BESs include, microbial fuel cells (MFCs) and microbial electrolysis cells (MECs), which convert organic or inorganic molecules into electricity and hydrogen, respectively (Borole, A. P. (2015). “Microbial Fuel Cells and Microbial Electrolyzers.” The Electrochemical Society-Interface 24(3):55-59.”

### SUMMARY OF THE INVENTION

In one aspect, the present invention provides a method for preparing MEC comprising an anode, a cathode, and a membrane; establishing a biofilm on the anode while increasing the cell voltage from 0.4V to a value up to a cell voltage of 1.7V, with the cell voltage controlled by a control loop; maintaining an anode potential at an anode voltage vs. a reference electrode potential, and generating a desired current density of at least 5 A/m² by augmenting an organic loading rate, wherein the organic loading rate ranges in value from 0 to 100 grams of a substrate per liter of anode volume per day; and maintaining the desired current density by varying the anode voltage, the organic loading rate, the cell voltage, or a combination thereof. In embodiments, the desired current density is at least about 10 A/m². In embodiments, the anode voltage comprises about −0.4V, about −0.35V, about −0.30V, about −0.25V, about −0.20V, about −0.15V, about −0.10V, about 0.05V, about 0.00V, about 0.05V, about 0.10V, about 0.15V, about 0.20V, about 0.25V, about 0.30V, about 0.35V, or about 0.40V. In a further embodiment, the method comprises removing excess biofilm from the MEC comprising passage of a low or high pH solution through the anode, cathode, or both; sonication via an MEC-sonicator or like device; or a combination thereof. In another embodiment, the method further comprises creating a product that is created during the steps of generating and maintaining the desired current. In an embodiment, the product comprises hydrogen. In a further embodiment, the hydrogen is used for production of one or more chemical products. In an embodiment, the product is a chemical derived from protons, electrons, and any other added chemical.

In another aspect, the present invention provides a method to maintain a high current density in a BES of at least 1 A/m², wherein the BES comprises a microporous membrane or an ion-exchange membrane, and the method comprises: pulsing a flow of a fluid through an anode at a frequency of 0.00001 to 10 Hz, such that periodic convective flow occurs between the anode and a cathode; and maintaining a cathode pH at a value of less than 13. In embodiments, the BES membrane comprises an anion exchange membrane, and the flow of the fluid through the anode is pulsed at a frequency between 0.00001 to 10 Hz. In embodiments, BES membrane comprises a cation exchange membrane, wherein the flow of the fluid through the anode is pulsed at a frequency between 0.00001 to 10 Hz.

In another aspect, the present invention provides a method to maintain a low pressure drop across an anode in a BES comprising measuring a negative pressure drop; and if the negative pressure drop is above 1 PSI/min, removing excess biofilm to maintain the low pressure drop across the anode. In an embodiment, the negative pressure drop is performed with a vacuum test. In an embodiment, removing excess biofilm is performed by applying a low or high pH solution or sonication.

Other objects and advantages of this invention will become readily apparent from the ensuing description.

### BRIEF DESCRIPTION OF THE FIGURES

FIG. 1 shows the design of MEC under two embodiments. Panel A shows a side view, front view, and back view of a rectangular configuration. The back view shows one of the exemplary spacer designs. Nonexclusive, alternate designs include more dense baffles or bidirectional baffles with gaps for gas and liquid flow; Panel B shows a circular configuration (top view is shown.)

FIG. 2 shows a schematic representation of MEC with microporous membrane showing operational characteristics of the process under one embodiment. An MEC using microporous membrane facilitates convective flow from anode to cathode, and vice versa, enabling better pH management. The liquid transferred to cathode is separated from the gas produced and recycled to anode, completing the loop. A sensor is embedded in the G/L separation trap which controls the liquid return rate from the trap to the MEC. Alternately, a reservoir may be placed in between the trap and the MEC to manage the flow into the MEC.

FIG. 3A shows an anode configuration with flow channel for better flow distribution under one embodiment.

FIG. 3B shows a spacer-distributor for the cathode. The cathode electrode can be planar or 3-dimensional, while the spacer is 3-Dimensional to allow upward flow of product gas/liquid from the cathode. A second configuration of the cathode spacer can be similar to the flow channel configuration shown for anode in FIG. 3A.

FIG. 4 shows cyclic voltammetry of MEC anode showing low midpoint potential of bioanode.

FIGS. 5A1-A3 show diagram of anode voltage and organic loading rate control loops and the associated process control device under one embodiment.

FIG. 5B shows the graphical user interface for the complete MEC control system.

FIG. 6 (panels A and B) shows graphs of response of MEC anode voltage and current as a result of perturbation in operating conditions of MEC under one embodiment. Conditions: Response time=5 min, with differential voltage gradient-based change, set-point −0.29 to −0.31V.

FIG. 7 (panels A and B) shows graphs of responses of MEC to increase in response time from 5 minutes to 10 minutes, while using the same differential voltage gradient criteria for anode voltage.

FIG. 8 (panels A and B) shows graphs of responses of MEC to change in control criteria from differential voltage gradient to a simple increase/decrease in anode voltage, while using a response time of 10 minutes for the upper limit and 20 minutes for the lower limit.

FIG. 9 (panels A and B) shows graphs of response of MEC using pulsed flow and voltage deviation from set limit as the primary stimuli with a response time of 10 minutes for the upper limit and 20 minutes for the lower limit.

FIG. 10 shows a graph of current and voltage response of MEC with substrate feed control which shows autonomous control of the feeding rate based on current.

FIG. 11 (panels A and B) shows graphs of effects of pulsed flow on MEC performance parameters. Results are shown for two duplicate MECs (panel A and panel B), indicating reproducible effect leading to a >50% increase in current production due to pulsed flow vs. continuous flow.

FIG. 12 shows an exemplary device setup for pressure drop measurement across the MEC anode.

FIG. 13 panels A, B, and C show exemplary integrated MEC-Sonicator for disruption and removal of excess biofilm.

FIG. 13D shows the results from sonication on hydrogen production.

FIG. 13E shows the results from electrochemical impedance spectroscopy (EIS) of the MEC before and after sonication.

FIG. 14 shows images of exemplary microbial electrolysis reactors.

FIG. 15 shows a graph of current (mA) vs time (h). Continuous increase in current production achieved via anode voltage control and regulation of organic loading rate.

FIG. 16 shows a graph of anode voltage vs. time (d). Operational control of anode voltage via maintenance of cell potential and OLR at pre-determined ramp rate.

FIG. 17 shows a schematic of an integrated, multi-disciplinary approach to develop MEC technology, under one embodiment. Direct electron transfer-capable complex microbial communities, combined with fast charge transfer and bioelectrochemical process control lead to high rate of hydrogen production.

FIG. 18 shows a graph of an exemplary microbial community for converting real food waste to H₂ and a graph showing MEC performance showing current production that generates 20 L-H₂/L-day in a 2 cell, 800 mL reactor.

FIG. 19 shows a non-limiting example diagram of MEC and cathode.

FIG. 20 shows a diagram of a non-limiting example of a scale-up strategy using 5× increase in cell size followed by a non-limiting example of a design of stack and module for distributed generation.

FIG. 21 shows a diagram of an example of non-limiting process steps which can be involved in converting complex waste into hydrogen and associated impedance elements.

FIG. 22 shows a non-limiting example of performance metrics for MEC technology for biomass hydrolysate and food waste (FW).

FIG. 23 shows an example of a prototype of existing MEC stack tested using real food waste.

FIG. 24 shows a non-limiting example of integrated system consisting of press, MEC module, and compressor.

### DETAILED DESCRIPTION OF THE INVENTION

Aspects of the invention are drawn towards bioelectrochemical process control, methods of use thereof, and maintenance protocols regarding the same.

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

In various embodiments, the present invention relates to a method for preparation of a microbial electrolysis cell. The method can include (i) establishment of an electrogenic biofilm, with direct control of the cell voltage, to restrict and maintain the anode voltage in a specified range, and the organic loading rate; (ii) maintaining the MEC performance by controlling the flow of the fluid through the anode and/or cathode, and (iii) removing excess biofilm from the MEC via passage of low or high pH solution through the anode and/or cathode, or via sonication using the integrated MEC-Sonicator, or a combination thereof.

In one aspect, the invention is directed to a method for preparing a microbial electrolysis cell (MEC) for functional use. In another aspect, the invention is directed to the MEC itself, as prepared according to any one or more of the steps described below. In embodiments, the operation of the MEC includes a startup phase, a production phase, or a combination thereof. The startup phase can include MEC preparation/development. In embodiments, MEC preparation includes control of process parameters such as anode voltage and control of feeding rate or organic loading rate (OLR) and flow through the reactor for improved growth of the anode microbial biofilm catalyst. After completion of the startup phase culminating in the MEC reaching a predetermined performance, the production phase can be initiated. The functional parameter to be controlled for production of the target product discussed in this invention includes pulsed-flow through the MEC. In addition, maintenance protocol for periodic removal of dead and excess biofilm from the anode can be incorporated for stable, long-term performance of the BES, which can also include control of anode voltage.

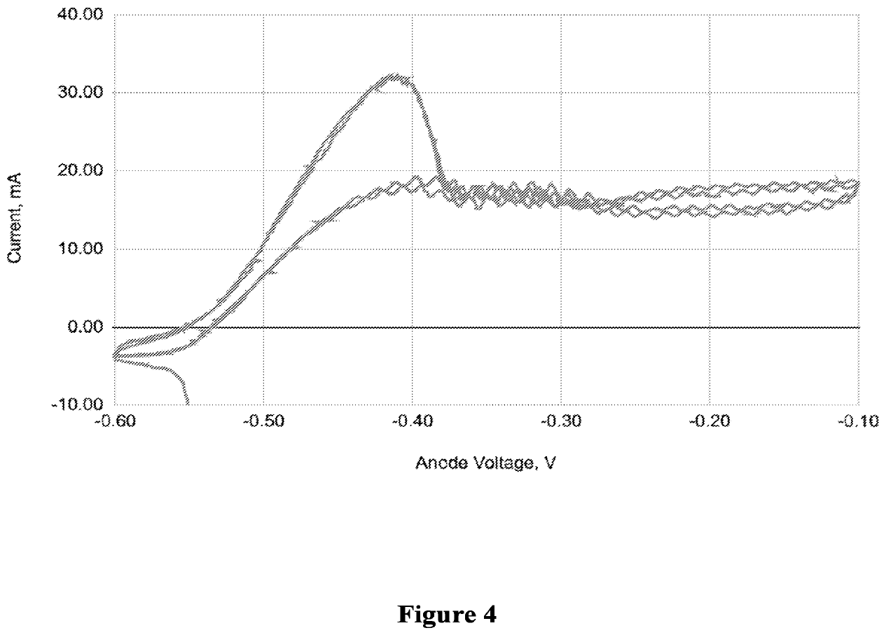

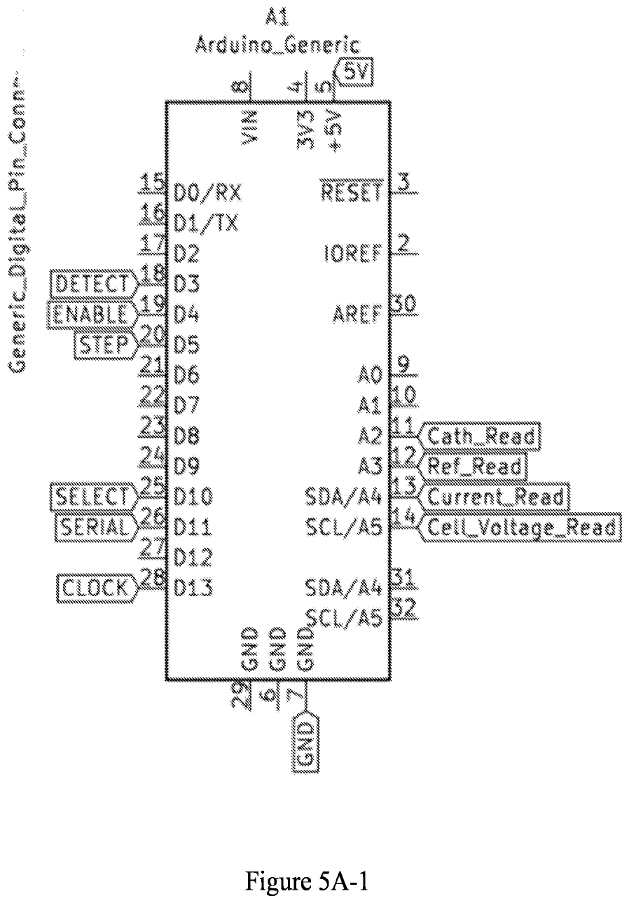

MECs can need external electrical energy to produce hydrogen, which can be supplied via a power source at a voltage between 0.5 to 2 V. One process parameter discussed herein is the control of anode voltage during the startup phase of the MEC through control of the cell voltage. Control of the anode voltage is described for achieving optimal development of the bioanode. Commercial production requires use of thousands of individual cells to achieve high volume production. While individual cells can be controlled via a potentiostat, use of such instruments is not economical for operation of thousands of cells. The inventive method described herein allows an economical way of controlling electrochemical cells for enabling commercial production of fuels and chemicals. Additionally, commercial potentiostats have a limit on the current that they can handle, therefore, special hardware and electronics are required to operate and control systems with current more than 1 A. A plurality of parameters can be involved in development of bioanode, i.e., which refers to growth of an electroactive microbial biofilm grown on the electrode to serve as the anode, as well as for operation of the anode. These parameters include, but are not limited to, anode voltage, organic loading rate (OLR), cell voltage, liquid flow rate through the anode, or a combination thereof. A control loop involving the first three parameters can comprise a first component of one embodiment while keeping the flow rate constant. Controlling the anode voltage drives the electrons generated in the biofilm to the electrode on which it is growing (the anode), followed by transfer of the electrons via an external circuit to the cathode. This makes the cathode electronegative, creating a potential difference between the anode and the cathode. This difference between the anode and the cathode is referred to as cell voltage. During growth of the electro-active biofilm on the anode surface, the microbes generate a conductive extracellular matrix comprising redox proteins or biological nanowires that serve as a medium for transfer of electrons from the microbes to the anode surface (Reguera, G., et al. (2005), “Extracellular electron transfer via microbial nanowires”, Nature 435 (7045):1098-1101). The redox potential of the microbes reached as a result of the biochemical reaction converting organic molecules present in the feed (e.g. food waste) to electrons and protons can comprise about −0.55V 0.02V vs. Ag/AgCl reference electrode. Results from the bioanode embodiments described herein, have demonstrated a mid-point potential at or below about −0.4V based on cyclic voltammetry experiments (FIG. 4). In some embodiments, the mid-point potential comprises values ranging from about −0.5V to about 0V. In some embodiments, the mid-point potential comprises about −0.5V, about −0.4V, about −0.3V, about −0.2V, about −0.1V, about 0.0V, and intermediate values thereof. These results are similar to those reported previously (Lewis, A. J. & Borole, A. P. Adapting microbial communities to low anode potentials improves performance of MECs at negative potentials. Electrochimica Acta 254, 79-88 (2017)), indicative of a highly active electron-generating bioanode. Previous work, however, required a growth period of several months to achieve the electroactivity at low potentials. Prior to the present disclosure, methods to grow an electronegative anode working at or near −0.4V in less than a week, necessary for commercial application, without the use of expensive instruments such as potentiostats, have not been reported.

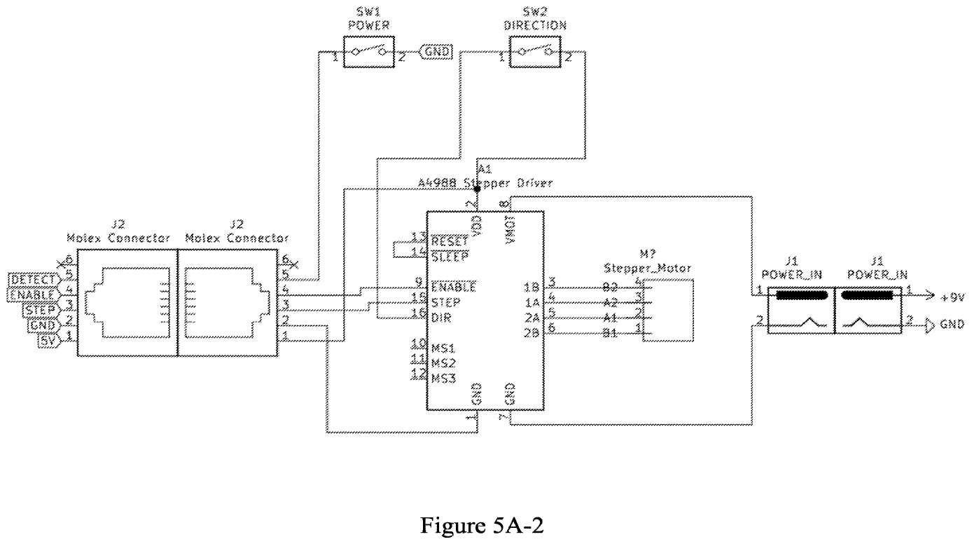

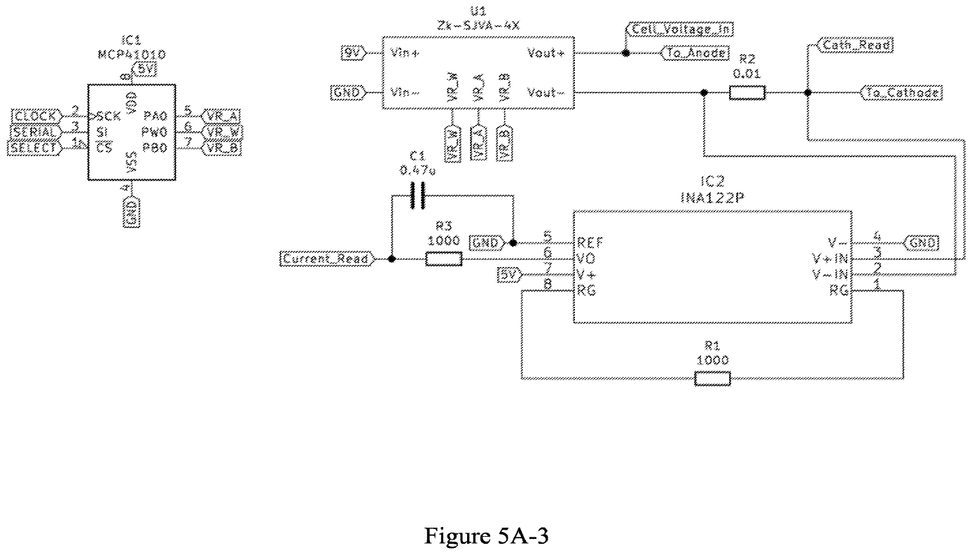

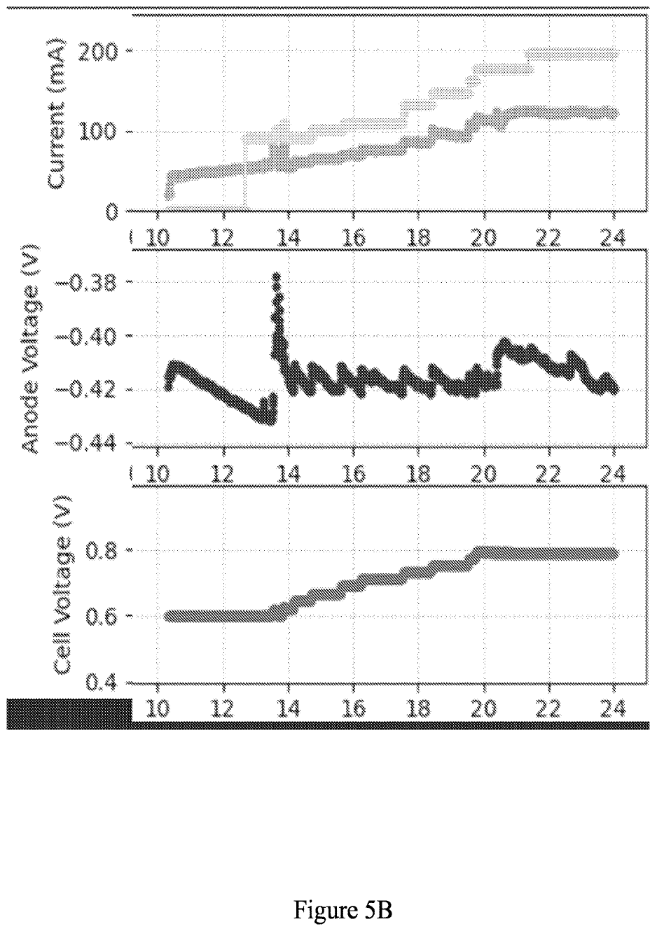

In embodiments, when an electroactive bioanode demonstrating a redox peak at or about −0.4V is poised at voltages above about −0.4V, transfer of electrons is initiated to the counter electrode (typically the cathode). During growth of such an electro-active biofilm, operating at the optimal redox potential, removal of electrons from the bioanode continuously can drive further growth of the electro-active biofilm to develop a high performance bioanode. Additionally, such control can also be implemented during production phase of MEC to maintain the anode potential in the desired range. In embodiments, this can be achieved via a shifting cell potential to accommodate the changing current from the bioanode, as the biofilm grows. A process for development of such a high performance electro-active biofilm, and for subsequent operation of the MEC for electron generation from organic molecules, without the use of an expensive instrument such as a potentiostat is described. This process can include control of the anode potential as a function of the growth parameters, operating parameters, or a combination thereof. Examples of such parameters include, but are not limited to the substrate feed rate, also referred to herein as the organic loading rate (OLR), and the applied cell potential, while producing current at its maximum value. A feed-back loop can be used to maintain the anode at a potential of about −0.4V, or alternately at any other value desirable or known in the art for optimal performance of the anode, and further depending on the substrate used and the desired product. In some embodiments, the substrate can comprise any one or more of the following: acetic acid, mixtures comprising acetic acid, sugars, carbohydrates, and biodegradable molecules, including organic waste such as food waste, biomass, etc. Substrate feed rate can be controlled by one or more devices known in the art, which, in embodiments, may also be operatively connected to the inventive system disclosed herein for automating the process control of the BES. This exemplary target voltage can be further dependent on the desired growth rate of the biofilm. In one embodiment, the anode potential is maintained at about −0.3V, by applying a cell voltage between anode and cathode and increasing or decreasing it incrementally by a few microvolts to maintain the anode voltage at about −0.3 vs the reference electrode of Ag/AgCl. This voltage can also be changed from a low level, for instance, about −0.5V, to a higher value such as about 0V during the course of the bioanode development. In embodiments a program can be implemented to control and change the set point. Such a program can comprise an automated control system, which can run on a computing device with a processor, such as a laptop, desktop computer, tablet and/or mobile device, whereby such device includes means to receive one or more inputs corresponding to the inputs described herein with respect to control and change of various parameters pertaining to the BES. It will be understood by a person having ordinary skill in the art that such a device could be operatively connected to one or more physical measurement devices known in the art to be used to collect, on a one-time or ongoing, real-time basis, measurements of the types described herein. One purpose of increasing the value of the setpoint as the biofilm grows is to accommodate for higher overpotential resulting from the increase in biofilm thickness. A thicker biofilm can contribute to higher mass and charge transfer limitations requiring such a change. As the biofilm grows, the current generated can increase, requiring an increase in another parameter, the OLR. This can be accomplished via a second control loop to increase the OLR as the current increases. FIG. 5 shows two exemplary control loops and an exemplary process control system developed to achieve the target control function.

TABLE 1
Determining response time via perturbation to cell voltage
and OLR. Results show control of MEC process via automated
anode voltage control and real time cell voltage adjustment.

| Test # | Perturbation |
|---|---|
| 1 | Response time = 5 min, with differential voltage gradient-based change, set- |
| | point −0.29 to −0.31 V |
| 2 | Differential voltage gradient-based change, Intermediate response time |
| | (±10 min), Fixed voltage step correction (10 mV), set-point −0.29 to −0.31 V. |
| 3 | Unequal response time for lower and higher limit deviation (+10/−20 min, |
| | respectively), Fixed voltage step correction (10 mV), set-point −0.30 |
| | to −0.32 V. |
| 4 | Unequal response time (+10/−20 min), Fixed voltage step correction (10 |
| | mV), Altered anode flow control (pulsed flow regime), set-point −0.30 |
| | to −0.32 V. |
| 5 | Automated substrate feed control, in tandem with voltage control |

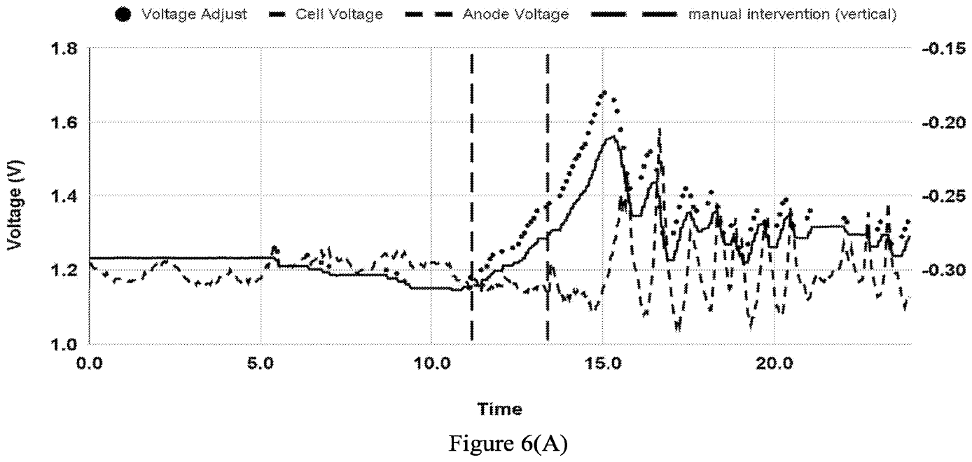

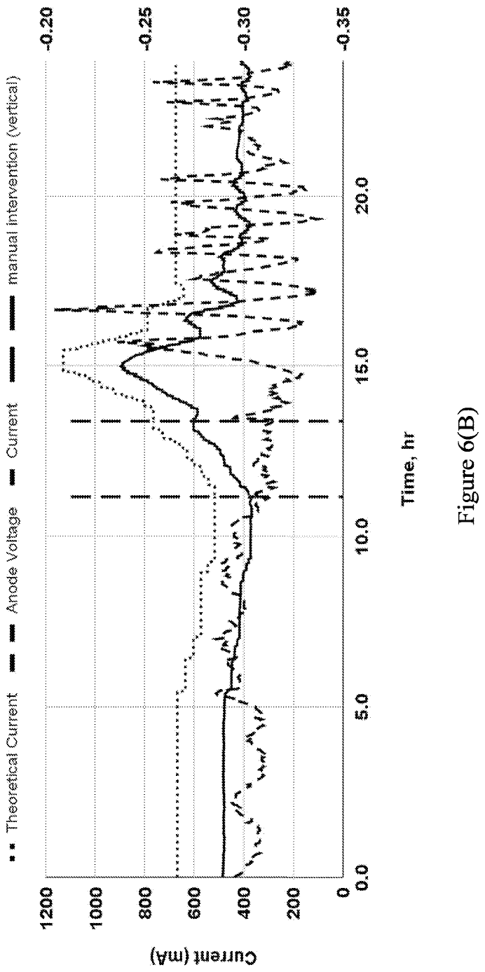

A MEC process can be developed by operating the MEC at the target anode potential, while maximizing current production. Biological systems such as MEC, which are influenced by redox potential, have a mechanism to sense the external redox potential. They react to external stimuli such as change in redox potential by changing the cellular processes occurring within the cell. This can involve up-regulation or down-regulation of certain genes; production of redox mediators, or biochemical molecules, and/or proteins; movement of biochemical entities within the cell, away from receptors or towards certain receptors or transfer in/out of compartments within the cell. These processes take a certain amount of time, from the moment a signal is received by the microbial cell to the time the cell completes its response. This response time can be critical in managing behavior of the MEC, including growth of the microbial cells in response to change in redox potential. The processes being developed in an MEC using microbial consortia are complicated by the presence of hundreds to thousands of different species with their individual proteins and enzymes responding to external stimuli. The present inventors have investigated the response of the complex microbial biofilm community being used in the inventive anode, according to some embodiments of the present invention, to determine appropriate response time for promoting the optimal performance of the MEC. The parameters important in establishing response time for a redox-based growth can include the anode voltage gain and loss as a function of the change in the cell voltage, current produced as a function of the OLR, which is dictated by the Coulombic efficiency of the bioelectrochemical system, the higher and lower limits of anode voltage within which to control the anode voltage, and the use of a fixed vs. differential voltage gradient with respect to time (dV_{anode}/dt). Each of these parameters were tested, either individually or together, to determine the appropriate logic to use for control of anode potential, so that it is maintained in the given range, which can enable optimal MEC performance. Table 1 shows the various tests conducted. FIG. 6 shows the effect of using a differential voltage gradient to set the cell voltage with a response time of 5 minutes on the control of the anode potential. The criteria for change in cell voltage was based on the dV_{anode}/dt. In other words, the sensor system measured the change in anode voltage as a function of time. As the anode voltage deviated from its set point range (in this case, −0.29V to −0.31V), the cell voltage was changed at a rate proportional to the dV_{anode}/dt. In other words, the increment by which it was changed was decided by the slope of the anode voltage change with time. Thus, a larger slope resulted in a large change in the cell voltage. This was followed by a wait time of 5 minutes (response time) to assess the anode voltage and determine if it has returned to a value within the limits. If not, another change in cell voltage was made, again depending on the slope. In embodiments, the use of a differential voltage gradient provides a proportional response in cell voltage to bring the anode voltage within the limits. Using this exemplary control criteria, the anode voltage was maintained for the first 12 hours as shown in FIG. 6. When the anode voltage became more positive than −0.29V, the cell voltage decreased, and vice versa. However, when a perturbation was introduced which impacted the anode voltage to a larger degree and/or in a repeated fashion (FIG. 6), the anode voltage started oscillating from above the higher limit to below the lower limit. This oscillation continued for over 10 hours. As the anode voltage overshot the limits and resulted in an oscillatory trend, the control criteria was unable to maintain the anode voltage in the target range. Thus, either the differential voltage gradient or the response time were inappropriate. Several additional tests were conducted to determine the root cause of this behavior. It was found that the response time was too low. Therefore, the next test was conducted with a higher response time.

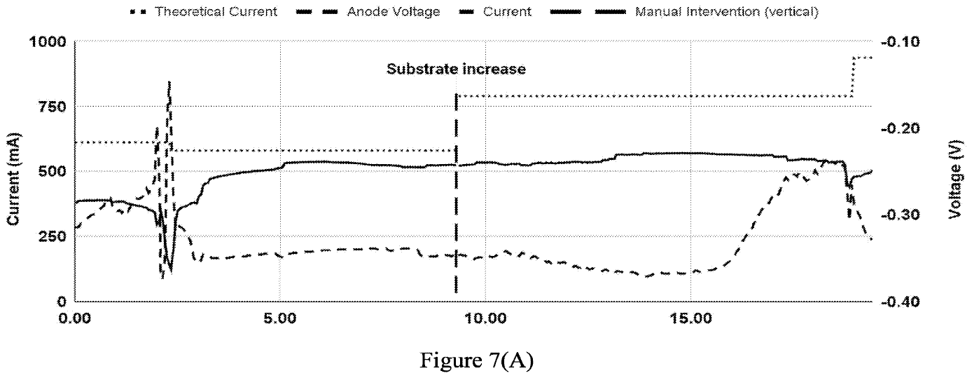

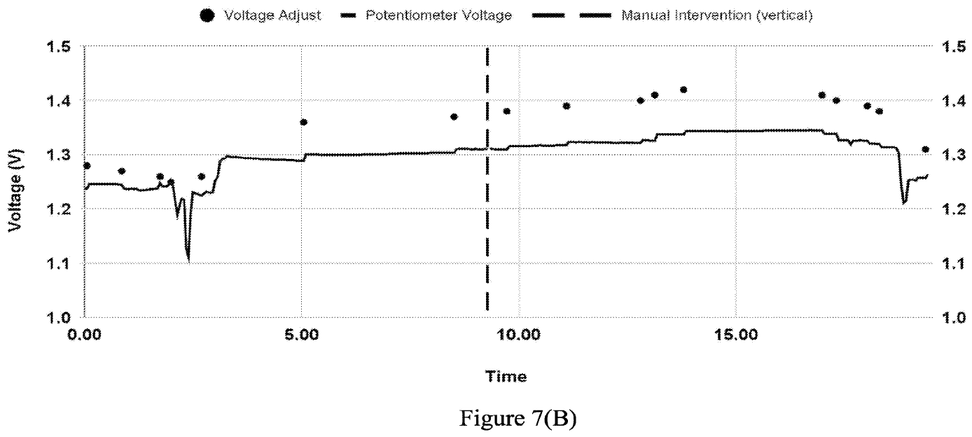

The results from the second test with a response time of 10 minutes are shown in FIG. 7. The response time constituted two parameters which can be independently set as a part of the control criteria. It was made up of voltage sensor measurements multiplied by a number of repeat occurrences required in an increasing or decreasing direction to set off the response. Measurements were made every 2-3 minutes and if the direction of change was the same for 4 consecutive measurements, the cell voltage was changed. Using this criteria, the cell voltage was adjusted whenever there was a deviation in anode voltage from the set point limits. This worked for the first 3 hours, but thereafter while the anode stayed outside the limits, the criteria for 4 consecutive measurements was not met. Therefore, the anode voltage remained outside the limits. Thus, this operating regime to keep the anode potential within the set limits required further revision to achieve optimal results.

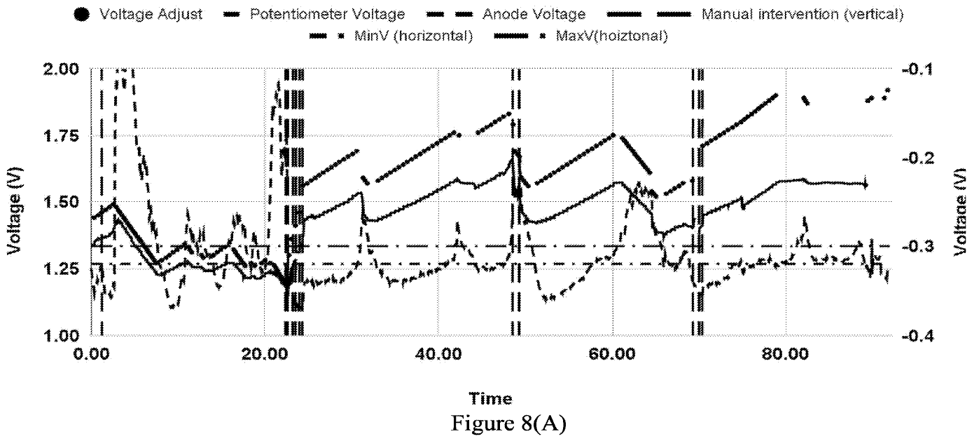

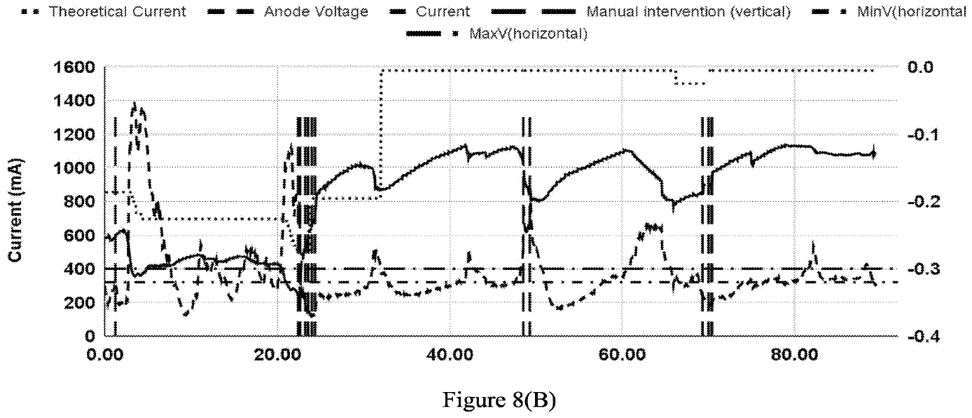

A change in the control criteria from differential voltage gradient to a simple voltage difference between the anode voltage and set point was made. Additional tests with different response times for the lower and upper range were also tested. The results from one of the tests conducted using simple voltage difference between the anode voltage and upper and lower limits with a response time of 10 minutes on the upper end and 20 minutes on the lower end are shown in FIG. 8. This condition prevented the anode voltage from oscillating, such as those observed with a 5 minute response time, however, the oscillations did not go away completely. A manual intervention of setting the cell voltage, however, brought the anode voltage within the limits and minimized further oscillations. This condition was stable for several hours without further manual interventions.

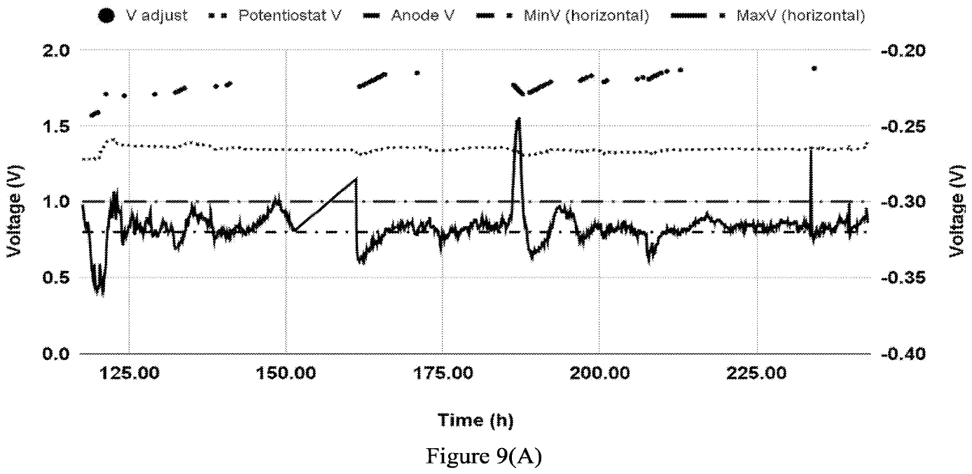

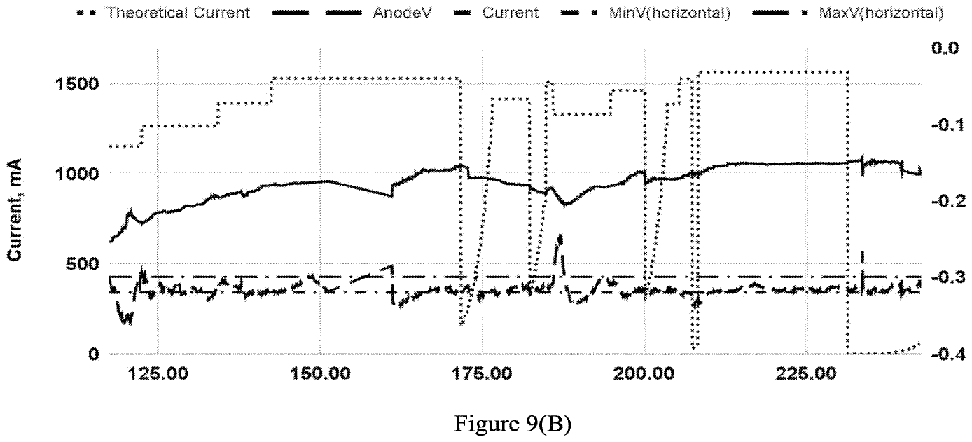

To stabilize the system further, a change in the mode of liquid flow through the anode was made. Instead of continuous flow, a pulsed flow was introduced. The pulsing was 2 seconds ON and 2 seconds OFF, controlling the total anode flow. This allowed the system to also react to changes introduced by parameters other than the cell voltage, as described herein. In FIG. 9, the result from stopping the substrate feeding on three different occasions sharply as well as a step wise change in the substrate feeding rate did not cause the anode voltage to go outside the set limits. Thus, the operating regime corresponding to the use of an anode voltage deviation from the set points above and below the limits, corresponding to a response time of 10 minutes and 20 minutes on the upper and the lower limits, followed by a 10 mV change in cell voltage, was able to control the anode voltage within the set limits. The present invention also comprises an automated system for control of the MEC operation, using voltage and current based sensors, implemented to control the MEC system. The inventive system automates the logic disclosed herein, enabling automated control of the MEC function for optimal performance. The inventive system can be used to automate control of any size of MEC or a stack of MECs, allowing autonomous control of the MEC operation. The response time can change depending on the size of the MEC, use of multiple MECs in stack or for use of the control system in other bioelectrochemical systems. The inventive method disclosed herein can be used to determine response factors and operational regimes, which can be completed manually or automatically via the inventive system, and the response factors and operational regimes thus determined can then be used as inputs to the active control portion of the system to control the inventive bioelectrochemical system autonomously.

Thus, embodiments of the present invention also include hardware and software systems for automating the processes described herein.

In some embodiments, the present invention may also comprise a second control loop to adjust the feeding rate based on the observed current. In some embodiments, the feed rate can comprise about 0.1 g/L-day to about 40 g/L-day or more. In certain embodiments, the feed rate is up to about 100 g/L-day. The feed rate can be about 0.1 g/L-day, 0.1 g/L-day, about 0.2 g/L-day, 0.3 g/L-day, 0.4 g/L-day, 0.5 g/L-day, 0.6 g/L-day, 0.7 g/L-day, 0.8 g/L-day, 0.9 g/L-day, or 1.0 g/L-day. In embodiments, the feed rate is about 1 g/L-day, about 2 g/L-day, about 3 g/L-day, about 4 g/L-day, about 5 g/L-day, about 6 g/L-day, about 7 g/L-day, about 8 g/L-day, about 9 g/L-day, or about 10 g/L-day. In certain embodiments, the feed rate comprises about 5 g/L-day, about 10 g/L-day, about 15 g/L-day, about 20 g/L-day, about 25 g/L-day, about 30 g/L-day, about 35 g/L-day, about 40 g/L-day, about 45 g/L-day, about 50 g/L-day, about 55 g/L-day, about 60 g/L-day, about 65 g/L-day, about 70 g/L-day, about 75 g/L-day, about 80 g/L-day, about 85 g/L-day, about 90 g/L-day, about 95 g/L-day, about 100 g/L-day, or a combination thereof.

In embodiments, OLR of about 1 g/L-day corresponds to a current density of about 1 A/m². Similarly an OLR of 20 g/L-day can correspond to a current density of about 20 A/m². In embodiments, the relationship between the ORL and the current density depends on the dimensions of the MEC used.

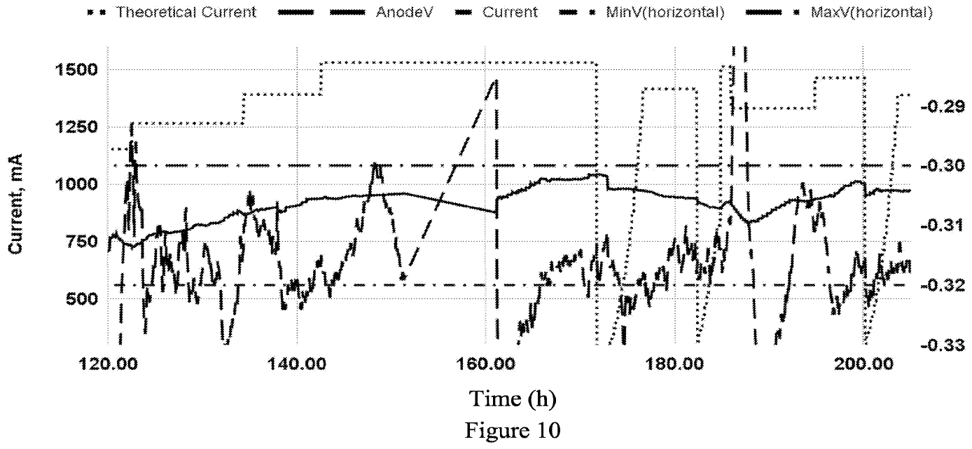

Each MEC can have a certain efficiency in converting organic substrate provided into current. Based on this efficiency and the concentration of organics in the feed stream a control scheme was developed by the present inventors to change the substrate feeding, to allow autonomous change in the feeding rate, once a given current production is achieved. The theoretical amount of current that can be generated from a set amount of substrate can be calculated from the substrate feed based on the chemical oxygen demand (COD). Once this theoretical amount is determined, the observed current can be compared and an upper and lower limit for efficiency can be set to maintain the feed rate as a function of the observed current. This allowed un-attended operation of the MEC to achieve a target current, once the feed tank is filled with substrate and the control program according to the present invention is initiated. In one exemplary embodiment, this scheme was implemented in parallel with the test for which the results are shown in FIG. 10. A clear response of the system can be observed beginning at the 173, 183 and 200 hours. The substrate feeding was manually set to a value corresponding to a theoretical current below 400 mA at each of these time points. Since the current production was high, the inventive control system quickly responded and increased the feed rate in a step wise manner to reach the rate corresponding to the current that required the feeding rate. The drop in current during this process was minimal. Thus, this exemplary embodiment demonstrates that the inventive control system can operate autonomously to change the feed rate to achieve high current production. In embodiments, this control loop may be used in tandem with the anode voltage control loop, optionally with each control loop functioning independently or in tandem. This allowed the control of the conversion of organic waste into current in the MEC system with minimal human intervention allowing control the feed rate and voltage for optimal performance.

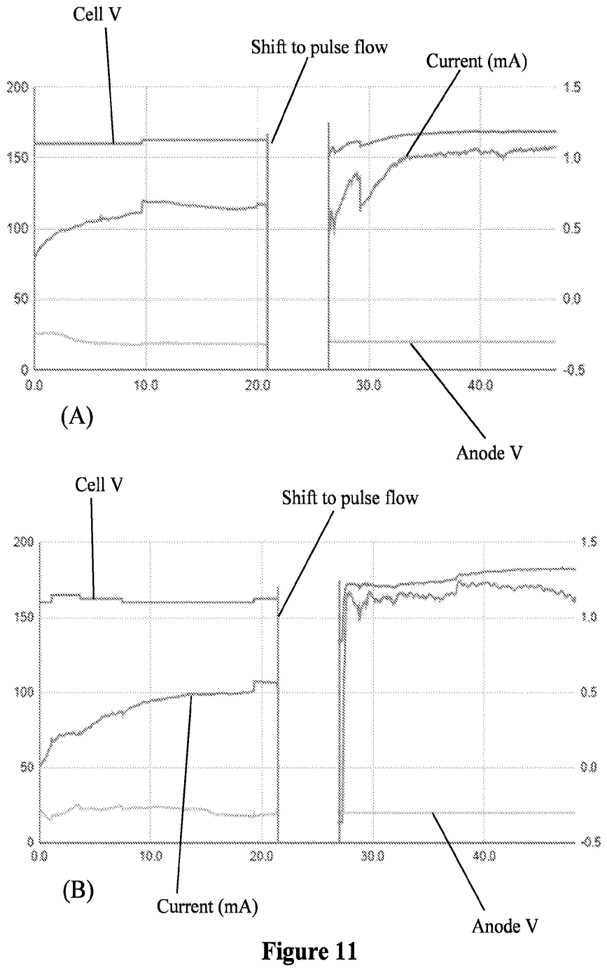

The second parameter which can be introduced in embodiments of this disclosure comprises the use of pulsed flow of the anode fluid, used earlier in conjunction with voltage control, for controlling the overall function and performance of the MEC. The pulsing of the flow rate, in itself, is a component within the MEC system. It can improve the performance of the MEC as explained below. FIG. 11 panel A and panel B show the effect of pulsed flow vs. continuous flow through a set of duplicate MECs in one exemplary embodiment. In this exemplary embodiment, the current production was increased by 50% going from continuous flow to pulsed flow. The anode chamber of the MEC contains microbes which generate electrons, protons and carbon dioxide produced from breakdown of organic molecules. The protons, carbon dioxide and any partially converted organic molecules produced within the biofilm growing on the electrode stay within the biofilm and transfer out slowly via diffusion. The use of pulsing of the liquid phase flowing through the anode allows improved transfer of the substrate and the products in and out of the biofilm, enabling improved performance. The pulsing of flow can be achieved using a diaphragm pump which can be intermittently powered or by gravity flow with controlled entry and exit. In embodiments, the frequency of the pulsing can be set to about 1 Hz. In embodiments, the pulsing can vary from about 0.00001 Hz to about 10 Hz. The pulsing frequency can comprise about 0.00001 Hz, about 0.0001 Hz, about 0.001 Hz, about 0.01 Hz, about 0.1 Hz, about 1 Hz, about 10 Hz, or any value between any of the foregoing. The magnitude of the pulse is a design parameter which is defined as the maximum flow rate of the liquid that can be flown through the anode without affecting the integrity of the system. The acceptable range for this parameter can between about 10 mL/min to about 1000 mL/min. For example, a parameter which can relate to the performance is space velocity. As used herein, the term “space velocity” can refer to the ratio of the flow rate to the cross-sectional area of the anode.

MECs contain an electrical barrier between the anode and cathode, which serves the function of ionic transfer and can include a microporous membrane, an ion exchange membrane, or a combination thereof. In MECs comprising a microporous membrane, the pulsing of liquid can provide an additional function of molecular and ionic transfer across the membrane. In addition to the movement of substrate and products in and out of the porous electrode and the biofilm enabled by the pulsing of flow, a microporous membrane can allow the transfer of the intermediates and anode reaction products from the anode chamber to the cathode chamber. The second half reaction required to generate the final product in a bioelectrochemical process, of which hydrogen is an example, occurs at the cathode. When hydrogen gas is the product, protons can be required to be present in the cathode, which can be transferred from anode to cathode or the counter ion, hydroxide, can be transferred from the cathode to the anode. Similarly, other products can require transfer of a charged species or ion across the membrane for balancing charge. Pulsing of liquid into an anode chamber with a microporous membrane can facilitate bidirectional transfer. Examples of such bidirectional transfer include the transfer of protons from the anode to the cathode, as well as the transfer of hydroxide and other anions from the cathode to the anode. This convective transfer is in addition to the charge transfer caused by applied voltage, which can primarily occur via diffusion. During the pulsing cycle in certain embodiments of the present invention, proton transfer takes place from anode to cathode when the pump is ON, while the transfer of counter ions takes places from cathode to anode during the off-cycle time when the pump is OFF. The pulsing nature of the inventive method can enable the build-up of pressure in the anode when the pump is on, and a drop in pressure when the pump is off. When pressure builds up in the anode, liquid can flow into the cathode, while when pressure drops in the anode, liquid can flow in reverse, thus, achieving a convective transfer between the anode and the cathode. In embodiments, a cycling of the liquid back and forth improves mass and charge transfer, in addition to the diffusion of ions that occurs naturally and due to potential difference between the anode and cathode.

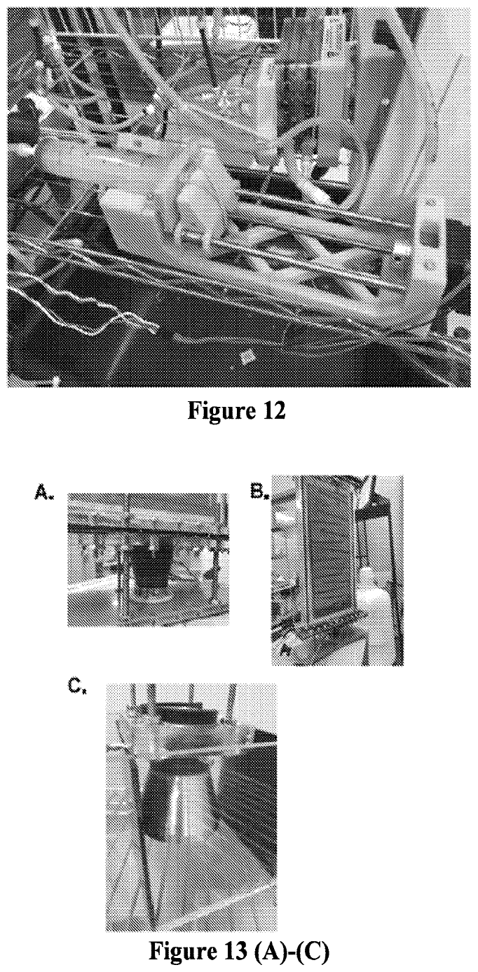

In embodiments, during the development or startup phase of the anode biocatalyst in the MEC, microbes are grown in the anode as a biofilm on the electrode. The pulsed flow can be gradually implemented during the development phase, by increasing the magnitude and the frequency of the pulse from zero to the maximum allowed in the system over time. The biological growth in the anode can have a yield of about 10-15% of biomass, building the biofilm over time. During the development phase/startup of the inventive process, the buildup gives rise to increasing current density. As the target performance is achieved, the build-up of the biofilm continues. The target performance can be maintained for several weeks; however, in embodiments, a periodic maintenance can be employed to remove dead and excess biofilm that grows over time. In embodiments, the periodic removal of biomass can ensure continued optimal performance at the target level. Where present in various embodiments, such periodic maintenance can be prompted automatically by the inventive system, at regular intervals or based on the system's determination of desired frequency, which can be based on measurement by the inventive system on any of the parameters disclosed herein. In embodiments, measurement of pressure drop across the anode (manually or by the inventive system) enables identification of the time when excess biofilm removal is needed. In embodiments, a method to supplement this method as an indicator of biofilm removal can be achieved via efficiency and yield analysis using the OLR, voltage, and current data. A constant flow can be used vs the pulsed flow during pressure drop measurement. This method includes use of a syringe pump and a pressure sensor to determine pressure drop (FIG. 12). By way of example, the method can include a vacuum test that includes connecting a tubing at the entry point to the anode chamber, through which liquid is pulled out for a specific period at a specific rate by the syringe pump. Such process can be done manually or, in embodiments, automatically by the system at predetermined intervals or based on the system's optimal timing based on detection of one or more variables described herein. Thus, in embodiments, a pump suitable for this purpose can be operatively connected to the system for automation of testing. If the anode chamber has excess biofilm, the pull of liquid by the syringe pump creates a vacuum at the entrance of the anode. As the negative pressure builds up, it can be continuously measured via a pressure sensor connected in-line. Once the predetermined volume is pulled and vacuum is created, the syringe pump can be stopped and the syringe can be allowed to return to an equilibrium pressure for a period of about 5-15 minutes. The time taken to reach a steady pressure at the end of this period is measured and can be used to determine the pressure drop. A pressure drop greater than about 1 psi/min is considered to represent at least one threshold for initiating removal of excess biofilm. The pressure drop is measured periodically, followed by a procedure to remove excess biofilm. Measurement of pressure at the anode inlet via a sensor can provide information on frequency to measure the pressure drop. A pressure sensor suitable for this purpose can be operatively connected to the inventive system for this purpose. The pressure drop measurements can be performed anywhere from a frequency of a week to a month. In embodiments, pressure drop measurement frequency is greater than one month. The frequency of pressure drop measurements can be less than one week. In embodiments, pressure drop measurements are performed every day, every 2 days, every 3 days, every 4 days, every 5 days, every 6 days, or every 7 days. Pressure drops can be measured multiple times in a single day. In embodiments, pressure drop is measure about every hour. In certain embodiments, pressure drop is measured about once a week, about every 2 weeks, about every 3 weeks, about every 4 weeks, about every 5 weeks, about every 6 weeks, about every 7 weeks, or about every 8 weeks. An inlet pressure change of about 3 psi can be a signal to measure pressure drop.

An exemplary method for excess biofilm removal is outlined below.

The description below outlines the software, hardware, and operating procedures used in one embodiment of the pressure drop measurement tests. However, it will be understood by one of ordinary skill in the art that any number of commercially available or hereinafter developed devices and systems which provide the same or similar functionality as the devices and hardware and software systems described below and herein can be utilized without departing from the scope and spirit of the present invention.
Software
   Arduino: CP2_xxxxxx_GUIino
   Python: MEC GUI Controller_xxxxxx_GDrive.py
Hardware
   A4988 Stepper Motor Driver
   Nema 17 Bipolar Stepper Motor
   Arduino Mega/Uno/Nano
   3D printed and assembled syringe pump frame
Operation
   1. Connect a 9V power source to the specified plug on the syringe pump.
   2. Specify direction (push/pull) by the marked rocker switch, and then flip the marked power rocker switch.
   3. Unless stopped manually, the syringe pump will operate for a set runtime of about 0.1-10 minutes defined in CP2_1_GUIino. At the end of operation, either automatically or manually ended, pressure sensor data can be logged for few minutes until steady pressure is reached. At this point, the power switch can be flipped to the off position to avoid accidentally continuing operation. This data is stored as ExperimentData_“date”.txt in a suitable folder accessible to the control PC.
      A. During the two minutes period of data collection, the syringe pump can be restarted by flipping the power switch to the off position, and then back to on. This will prematurely end data collection, and will begin a new two minute period once operation has ended again.
   4. At the end of the data collection period, or once the desired amount of time has passed, the syringe pump can be returned to its default position by reversing the direction and flipping the power switch back to the on position.
   5. When a division needs to be placed in the collected data (ex: moving between reactors), this can be done by renaming the current data file to indicate what was recorded. (Ex: ExperimentData_xxxxxx.txt to MEC_X_predeplugging_xxxxxx.txt) This will cause a new data file to be created during the next data collection period.
   6. When testing is complete and the syringe pump has been reset to a desired state, simply disconnect the 9V power supply.

The anode chamber can be filled with an acidic/basic buffer solution with a pH between about pH 2 to about pH 4 or between about pH 11-14. The acidic/base buffer solution can comprise HCl, NaOH, acetic acid, or any other acid/base buffers known in the art. In some embodiments, the acidic/basic buffer solution comprises a concentration of between about 0.1M to about 3M. Prior to use of the extreme pH in the MEC, the existing fluid can be removed and replaced with deaerated water. The water can be flushed through the MEC as well to remove all the previous fluid. Then, the buffer can be flown through the anode in a direction reverse to that of normal flow to contact with the biofilm in the anode. A volume equal to at least 1× the volume of the anode chamber can be flown through the anode. The buffer can be retained in the anode and recirculated for a specific period. In embodiments the specific period comprises between about 5 and about 60 minutes, inclusive. The buffer can then pulled from the anode in a direction reverse to normal flow direction to remove detached and excess biofilm and any planktonic microbes that have come loose from the electrode. This microbial biomass can be disposed of after inactivation and the anode can be filled first with water to wash off any remaining cellular biomass and then with deaerated anode fluid that can be used for normal MEC operation. The pressure drop can be measured again, as described herein. The acid/base flush procedure can be repeated until the desired pressure drop is achieved.

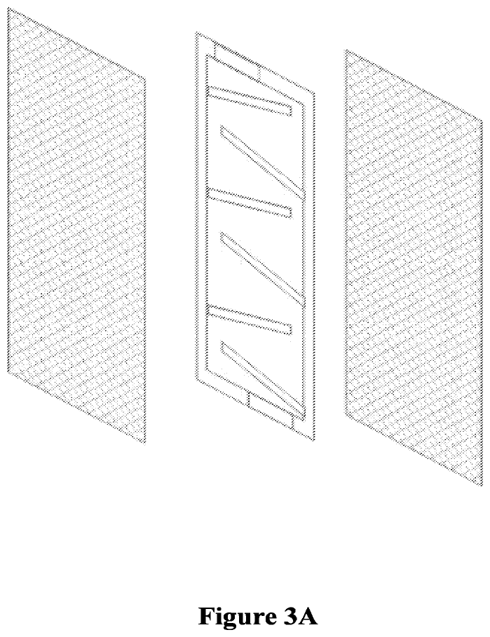

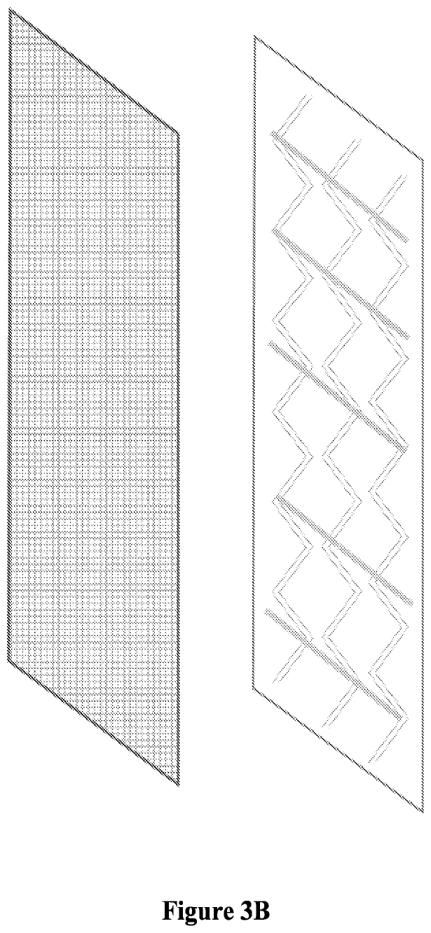

Flow through a porous anode with constant biofilm growth can result in the need for excess biofilm removal on a frequent basis. In a different embodiment of the MEC, a modified configuration is used, wherein the anode has a different path for flow of the substrate and planktonic microbes present in the consortium, provided by a patterned flow through the felt material for improved distribution of substrate as well as improved recovery of the product. This can be achieved by introduction of a channel into the anode via a metallic or polymeric insert. In one embodiment the flow channel can comprise a serpentine path allowing better distribution. The flow path facilitates influx and outflow of the liquid into the porous parts of the anode, the biofilm and the other parts of MEC allowing overall improved mass and charge transfer. Two exemplary patterns for such flow channels are shown in FIGS. 3A and 3B.

In embodiments, a method can comprise starting with an anode voltage of −0.4V, and gradually increasing said voltage as the current density increases to either a preset or system-determined maximum voltage. According to embodiments of the present invention, the inventive system automatically controls the voltage so as to allow the MEC to develop an optimal path to electroactive biofilm growth in due course, using the methods described herein. In some embodiments, the inventive system can include access to a database of different types of microorganisms capable of use in an MEC, cross referenced with their optimal redox potentials, to enable the system to automatically determine the optimal maximum voltage, starting voltage, rate of increase of voltage, or other parameters. In other embodiments, the system can access such a database of microorganisms and make recommendations to an operator who can then determine present operating parameters such as those noted immediately above.

### Examples

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1—MEC Construction

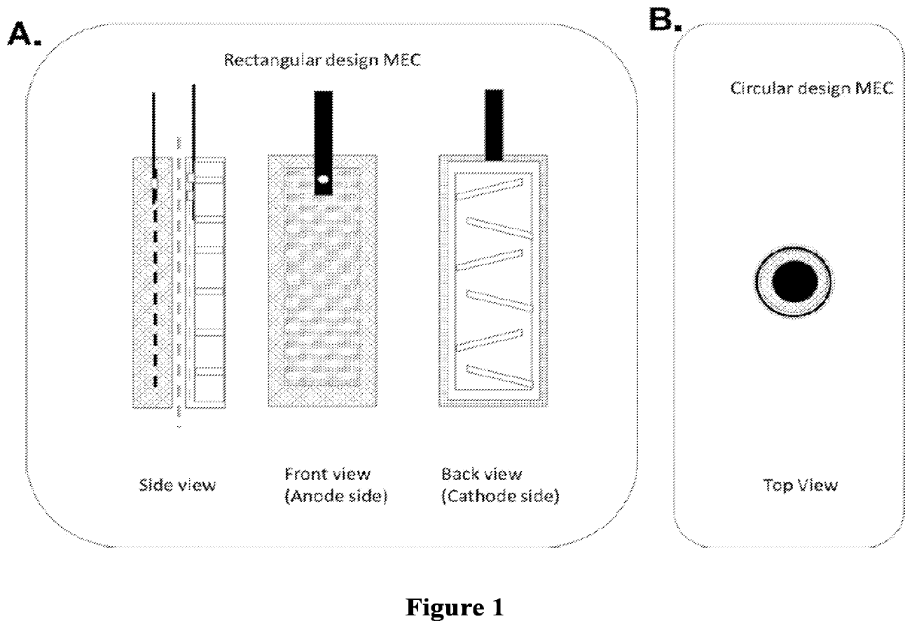

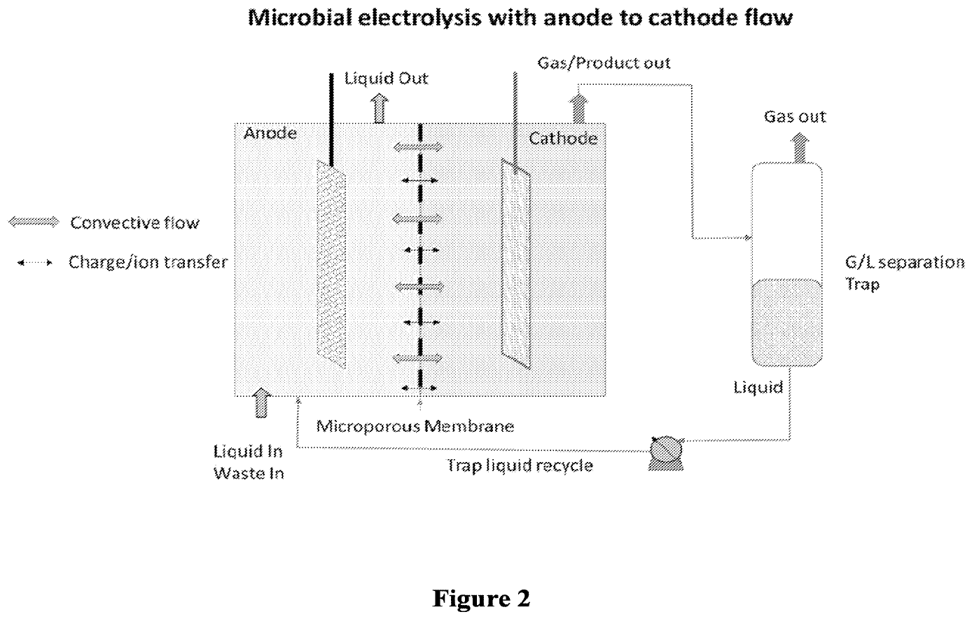

The MEC unit can comprise an anode, a cathode and a membrane separating the two. In one embodiment, the anode comprises a carbon material. The cathode can be made using a hydrogen-producing, electrocatalytic metal mesh electrode, such as nickel or stainless steel. The membrane can comprise an ion-exchange (IEX) membrane or a microporous membrane. The construction of the cell can differ for IEX vs microporous membrane. FIG. 1 shows the cell which can be constructed using either IEX or microporous membrane. FIG. 2 shows the cell and the convective mass and charge transfer possible with a microporous membrane. The configuration of the membrane can be rectangular (FIG. 1A) or a circular (FIG. 1B) cross-section. A current collector can be attached to the mesh in the cathode such as a stainless-steel plate or rod. In the anode the current collector can comprise a combination of a stainless-steel mesh and a plate or rod attached together with the mesh facing the carbon material, also attached via conductive glue or a metal connector. The anode carbon material can be any form of porous carbon, e.g. felt, cloth, foam, etc. The cell design allows liquid to flow across the carbon material in a horizontal direction in the rectangular design or radial direction in the circular design enabling substrate supply to the biofilm. The anode can contain a separate channel for improved distribution of the food waste, where the channel also allows use of planktonic fermenters which work syntrophically with the electron-generating bacteria growing as a biofilm on the anode electrode.

### Example 2—Inoculation and Operation

The anode can be inoculated with a microbial culture which is then allowed to grow on the anode carbon material forming an electroactive biofilm. A nutrient medium can be circulated through the anode to supply necessary mineral salts, vitamins, and chemicals to promote growth. The liquid can be supplemented with a source of carbon and energy, which is typically the feedstock used to produce hydrogen, supplemented with acetate. The feed can comprise food waste, biomass waste, combinations thereof, or liquid derived from such materials, combined with acetate or suitable substances thereof. The ratio of the acetate to waste is decreased from inoculation time to the end of growth phase. For example, the ratio can vary from about 99% acetate:about 1% waste to about 1% acetate:about 99% waste. The growth period can last a few days, depending on the microbial culture and the target hydrogen productivity. During the growth phase, transfer of the liquid from the anode to the cathode can be reduced to allow flow of liquid through the entirety of the porous anode via control of pressure differential between the electrode chambers.

### Example 3—Non-limiting Exemplary Application of Microbial Electrolysis System for Conversion of Biowastes into Low-Cost Renewable Hydrogen

### 1.0 Non-limiting Exemplary Impact of MEC Technology

Without wishing to be bound by theory, the microbial electrolysis technology disclosed herein can accelerate commercial deployment of bio-based pathways by drastically increasing hydrogen yields in MECs while producing >20 L-H2/L_{Reactor}-day (referred to as L/L-day) productivity. Furthermore, designs using low cost materials, automation, and maintenance are described herein that can sustain performance and enable lower production costs with a path to $2/kg. The presently disclosed systems and methods can be deployed in a real-world environment with industrial partners to demonstrate the two-pronged operational benefits of abating waste management costs, while producing a renewable source of hydrogen onsite for use in fuel cell equipment.

### 2.0 Non-Limiting Exemplary Technical Description, Innovation, and Impact

### 2.1 Non-Limiting Exemplary Relevance and Outcomes

### 2.1.1 Microbial Electrolysis Technology:

We have developed microbial electrolysis cell (MEC) technology using integrated microbial communities, which combine fermentative and exoelectrogenic members to convert food waste and biomass organics into low-cost, renewable hydrogen. The co-location of multiple functionalities in the community promotes intermediate/product removal, thus giving high rates of electron generation from complex organic matter. The microbial community can be robust and industrially relevant, having evolved to tolerate inhibitory compounds including volatile fatty acids (VFAs), furans, and phenols and conversion of many of these compounds to electrons, to support hydrogen generation¹⁻⁴.

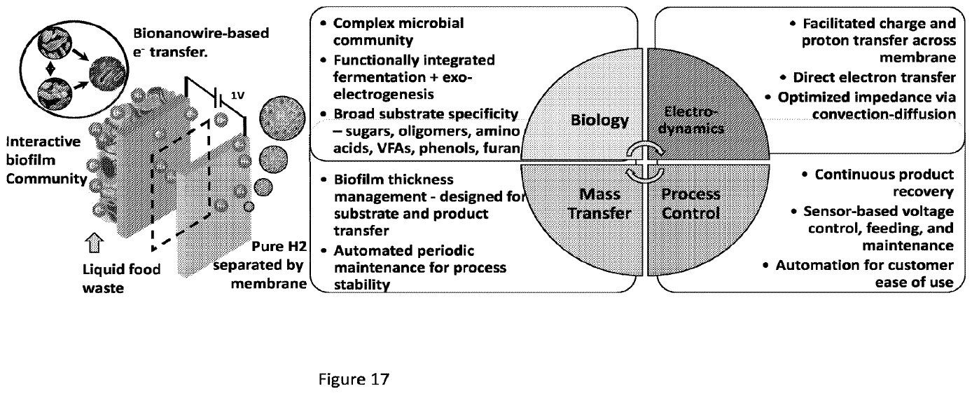

The community can break down waste organics into protons, electrons and carbon dioxide. The protons and other charged species are driven across a separator under the influence of an external voltage, with protons combining with electrons to evolve hydrogen (FIG. 17), which is removed from the reactor via pressure control. Sensors and electronics can allow the cells to run without frequent operator intervention. MECs can produce clean hydrogen from waste with higher electrical efficiency than water electrolysis, due to energy extracted from waste. The MECs designed can combine advances in biology and electrodynamics managing mass transfer and bioelectrochemical limitations via process control, as shown in FIG. 17.

### 2.1.2 Non-Limiting Performance Example:

Previous work on MEC technology development has addressed issues by using single chamber MEC reactors and explored nanomaterial-based electrodes and methanogen inhibitors to overcome issues. A hydrogen productivity of 20 L/L-d was reported using fermentation of sugars and hydrolyzates, but the H₂ yields were low. Work has been focused on development of microbial communities to convert biomass waste streams into hydrogen at high yields. This work indicated utilization of a diverse range of biomass sources including switchgrass, corn stover, etc., coupled to various pretreatments reaching hydrogen productivity of 20 L/L-d⁵⁻⁷. Work has demonstrated the MEC concept for hydrogen production, the remaining technical challenges to be addressed are scale-up, performance, durability, and system/process engineering.

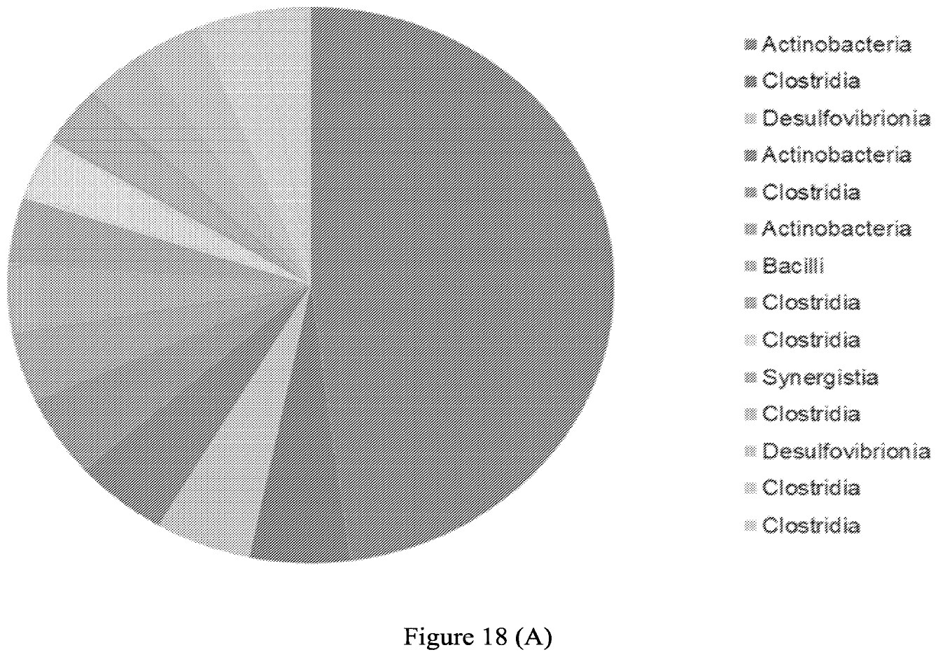

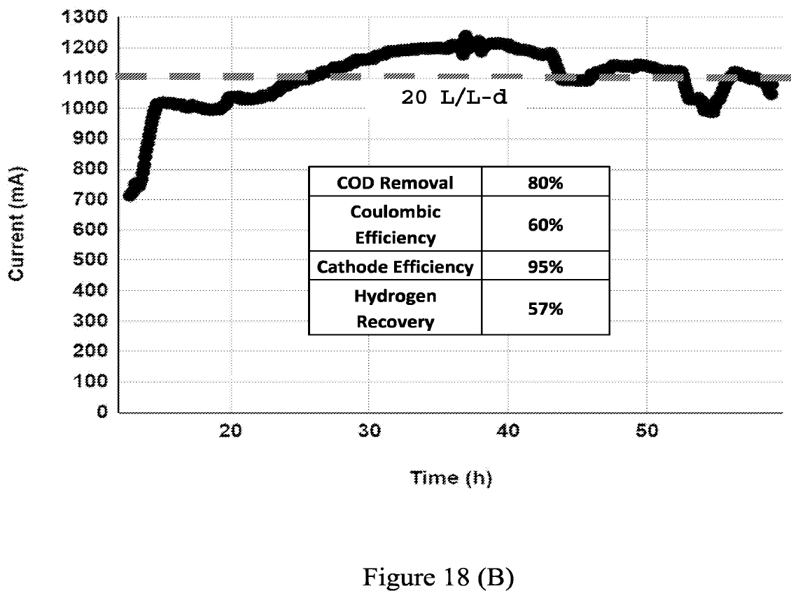

Communities capable of utilizing food waste were developed which can produce hydrogen at rates of 20 L/L-day or higher (FIG. 18). The baseline performance used in this example has an average productivity of 20 liters of hydrogen per liter of reactor per day (L/L-day) for a period of 48 hours.

### 2.1.3 Non-Limiting Examples of Advances in MEC Technology and Material Analysis

Design and process parameters tested comprise anode thickness, anode material, membrane type, cathode catalyst, organic loading rate, COD concentration, reactor volume, and area/volume ratio. Cumulatively, this has resulted in over 100 reactor-months of testing.

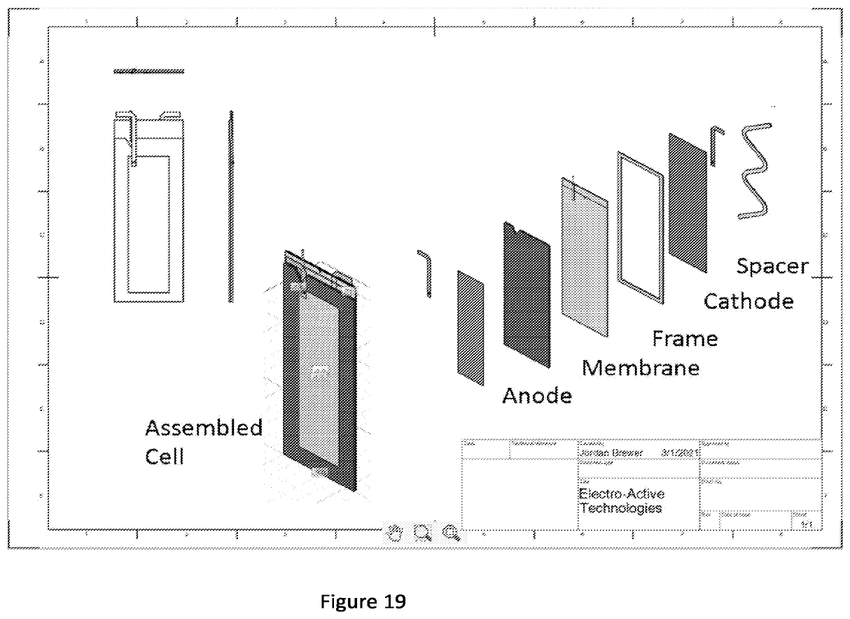

In an aspect, we can design the reactor, process conditions and control parameters for developing an exemplary embodiment. A diagram of the cell and exploded view of the cell are shown in FIG. 19. The system can use a microporous membrane which can prevent microbes from going into the cathode, but can allow ion transfer in both directions, a feature which makes this design capable of overcoming charge transfer limitations. This cell can generate hydrogen at the cathode. In embodiments, the cell generates hydrogen at the cathode that is up to 99.9% pure. Without wishing to be bound by theory, further purification exists via elimination of the nitrogen component via a H₂ flush. Studies with individual cells have used food wastes derived from two sources, a University cafeteria and a restaurant. The food waste can comprise food prep cuttings comprising different vegetables and fruits. The source can be diverse, to develop a microbial community with broad specificity.

### 2.1.4 Non-Limiting Examples of Technoeconomic Analysis

The strategy for cost reduction can be based on use of commercially available reactor materials, and working with manufacturers to develop advanced materials. We have developed a database of multiple vendors around the world and tested their materials including carbon electrodes, membranes and Nickel-based cathode materials. This can bring the cost of MEC reactor down.

### 2.1.5. Non-Limiting Example of Scale-Up

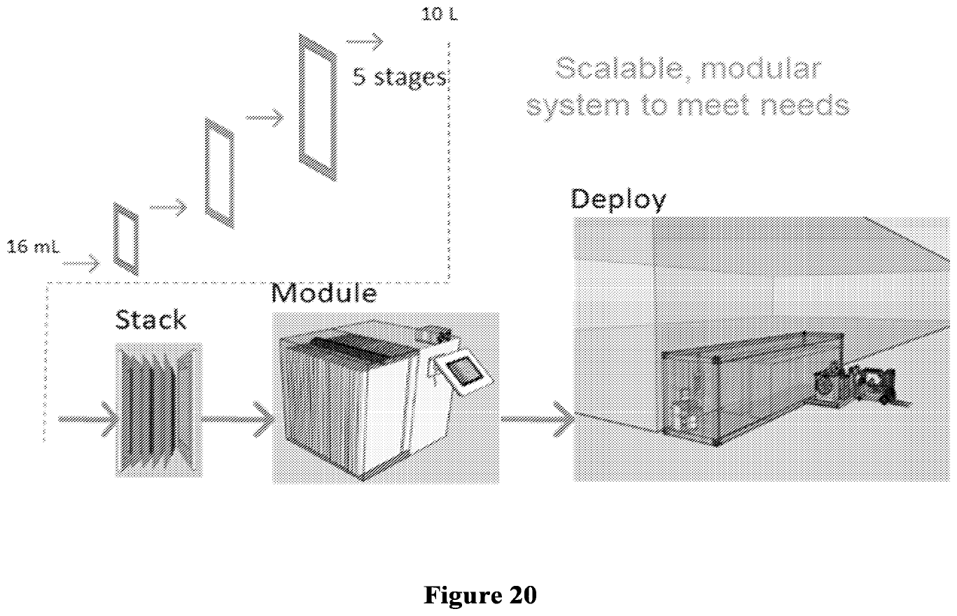

Overpotentials experienced can dictate the performance of the system and can be used to define the limitations of the system. In one embodiment, we are using an approach based on first principles via impedance analysis to identify the limitations. Electrochemical Impedance Spectroscopy is a tool, which can provide a blueprint of the bioelectrochemical systems existing in the MEC reactors and can delineate the impedance of the individual steps. These elements comprise resistance, capacitance, inductance, and Warburg diffusion⁸⁻⁹. We have conducted a detailed analysis of our reactors to identify each of these elements which can contribute to diffusion/mass transfer, charge transfer, redox reaction rate, and electron transfer and using it to understand scale-up. Identifying the size of an individual cell for commercialization is the first step in scale-up. Our approach uses a two-step process where we define the cell size, followed by the stack and module design. In order to determine the size of individual cells to use in a stack, we can use a 5× scale-up strategy. Reactor scale-up can require a stepwise increase in scale to understand the key scale-up parameters. Increasing the size 5-fold at each stage can allow us to identify these parameters (FIG. 20).

### 2.2 Non-Limiting Examples of Implementation

2.2.1. Non-Limiting Exemplary Results from Impedance Analysis

An exemplary EIS analysis of reactors at three different sizes found the overall impedance of the cell to decrease with increase in scale (from 20 to 1 ohm for cell size of 16 mL to 400 mL). Using total impedance as a primary parameter, we can identify the cell size to use for commercial systems. This analysis can affect long-term stability assessment of the system as well, since the overpotential can change with time and growth of the biofilm or changes in mass and charge transfer over time.

2.2.2. Non-Limiting Example of Improving hydrogen yield from complex biowastes

Limited yield of hydrogen from biomass or waste has been identified as a hurdle in commercializing the MEC technology. We can address this limitation in a combined approach consisting of multi-functional biocatalyst development and process improvement. The yield of hydrogen has been limited due to use of high loading conditions and the lower yield of electrons from fermentable substrates. Instead of using separate fermentation and exoelectrogenesis process steps, our approach can integrate them in single reactor. This can allow the VFAs to be generated and then used simultaneously by exoelectrogens to generate electrons, preventing accumulation of VFAs and providing a positive feedback loop that increases yield of electrons from biomass organics. The second limitation our approach addresses is the requirement of high concentration of the substrate biomass or waste in the fermenter for achieving high rates of conversion. The high concentrations can be used to overcome mass transfer issues and, without wishing to be bound by theory, biochemical kinetic limitations. This limitation can be addressed using a flow-through reactor design and modification of the substrate delivery method, while enriching microbes with a low Km that can enable higher conversion at lower concentrations. Flow through a porous matrix of electrode fibers can alleviate mass transfer in the reactor supporting biocatalyst growth. The ability to achieve high hydrogen yield (50-70%) at a range of hydrogen productivities (2.5-27.5 L/L-day) using low substrate concentration has been achieved in our reactors using a flow-through, continuous delivery mode showing the potential to improve yields significantly at organic loading rates ranging from 4-30 g-COD/L of reactor per day in 16-400 mL MECs.

### 2.3 Non-Limiting Exemplary Control System

### 2.3.1. Non-Limiting Exemplary Bioelectrochemical Process Control

We have developed a sensor-based process control system which can manage the voltages, feed rate and flows through the anode and the cathode along with feedback loops for sustained performance. This can be modified further. This can allow autonomous operation of a MEC stack prototype without an operator for days to weeks at a time.

### 2.3.2 Non-Limiting MEC Durability Example

Ability to maintain MEC performance over months of operation can be important. To achieve this, an ultrasonic mixing method has been developed for periodic, non-intrusive maintenance, and a MEC integrated sonicator has been developed.

### 2.3.3 Non-Limiting Impact Examples

MECs can provide a win-win solution to food waste. It can upgrade it to higher value hydrogen needed for clean and green transportation. About 33% of food is wasted worldwide. Without wishing to be bound by theory, compositions, devices, and methods herein can provide reduced emissions associated with food waste and use of hydrogen, enhanced energy security, emergency preparedness against disasters and restore US competitiveness internationally.

Development of new technologies such as microbial electrolysis can require several layers of innovations built into the product to result into a successful commercial application. We can combine technical innovations with business innovations to address problems based on market needs. There is a need for organic waste diversion (e.g., regulations such as SB1383 in CA, S2995 in NY, etc.). Our innovation can allow haulers and waste managers to meet state and local mandates by reducing waste volume and weight on-site by as much as 75%. This can be achieved via liquid separation and using it for hydrogen generation, reducing waste hauling costs, while generating a solid byproduct more suitable for composting. Overall this circular approach to hydrogen production and by product diversion can create a negative carbon pathway over the life cycle through reduced transportation, abatement of landfill emissions, and replacing fossil fuel use, enabling −82 kg CO₂/kg H₂ produced bringing additional marketable sustainability benefits to customers. This approach can fit into the current infrastructure allowing rapid penetration of the solution we can offer into the market.

### 3.1. Scaling-Up Core MEC Technology

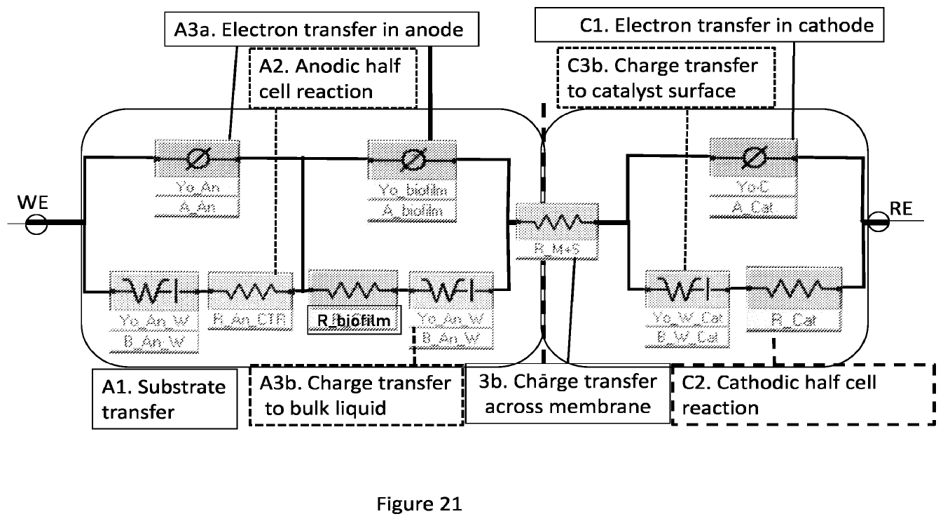

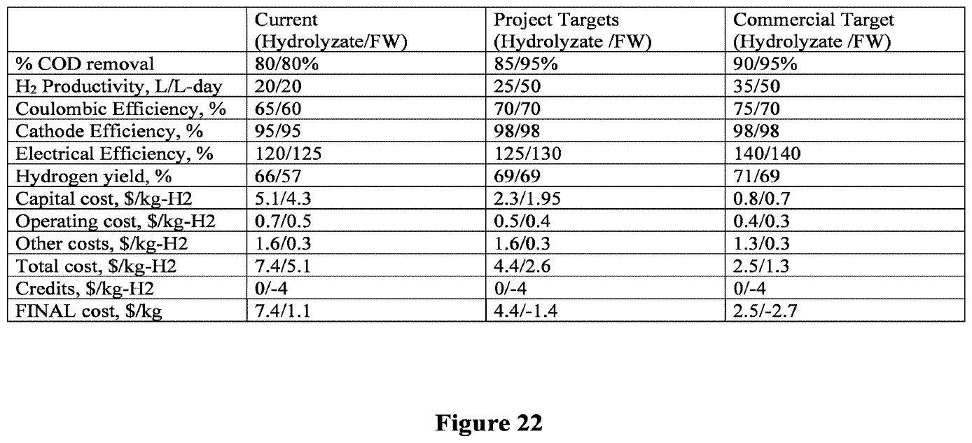

Production of hydrogen in an MEC can rely on steps, which occur in series or parallel which can range from breakdown of complex organic matter to the generation and recovery of hydrogen. Identifying the limiting parameters can assist in designing the system at scale. FIG. 21 shows the non-limiting, exemplary steps comprising mass transfer, charge transfer and redox/bio/chemical reactions involved. This work can include characterization of the impedance of these steps and relating them to the rate of conversion of waste organics and hydrogen production. The system can be designed for a fast startup as well as a high hydrogen productivity. Without wishing to be bound by theory, we can use EIS to determine impedance of each step using an equivalent circuit model (ECM) as shown in FIG. 21. The complexity of this model can be altered to represent changes we make in the system. We can determine the ECM parameters for MECs which can range from about 80 mL to about 10 L. An Arduino-based control system developed previously will be converted into a printed circuit board. Without wishing to be bound by theory, the board can include a power supply management system with voltage reduction from 120 V to 1.8V, sensors to monitor cell and anode voltage, current, pressure, liquid levels, pH and a control system to regulate feed rate into the anode and liquid flow rate for recirculation pump. A proprietary program and associated hardware developed previously can be upgraded to run autonomously using current and voltage feedback with regulation of substrate feed rate, hydrogen collection and its transfer to an external tank. Without wishing to be bound by theory, the control system can be installed on the stacks and meter cube units with a user interface panel to monitor the process on-site as well as remotely. Non-limiting exemplary, performance metrics and techno-economic targets are shown in FIG. 22 for individual cells. The effort focuses on improving productivity and yield of hydrogen from 20 to 50 L/L-day and 57 to 69%, respectively, to show commercial feasibility. A target is chosen for first demonstration of the assembled module (25 L/L-day and 40% yield).

### 3.2. Non-Limiting Sustained Operation Example

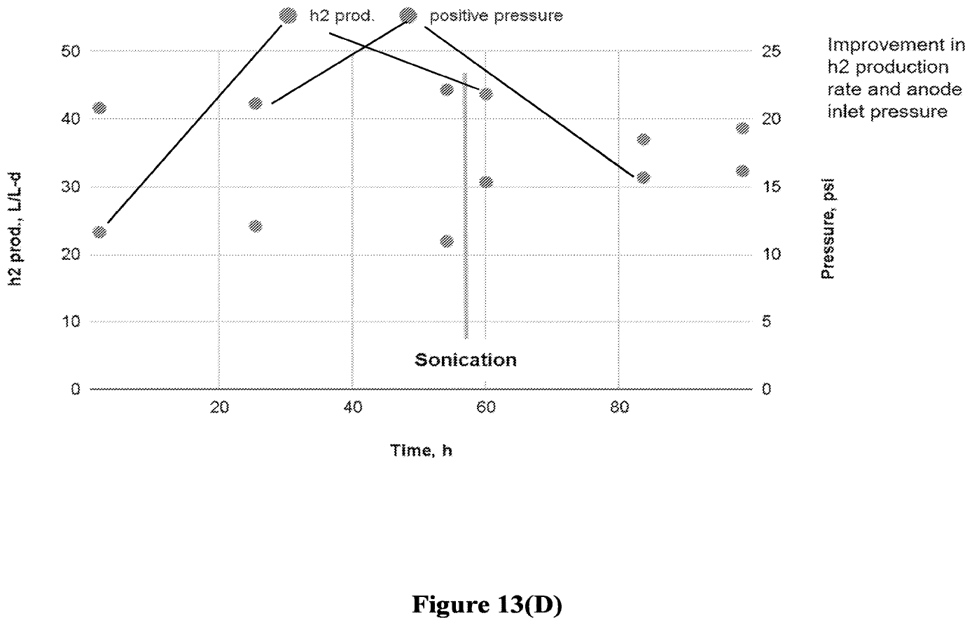

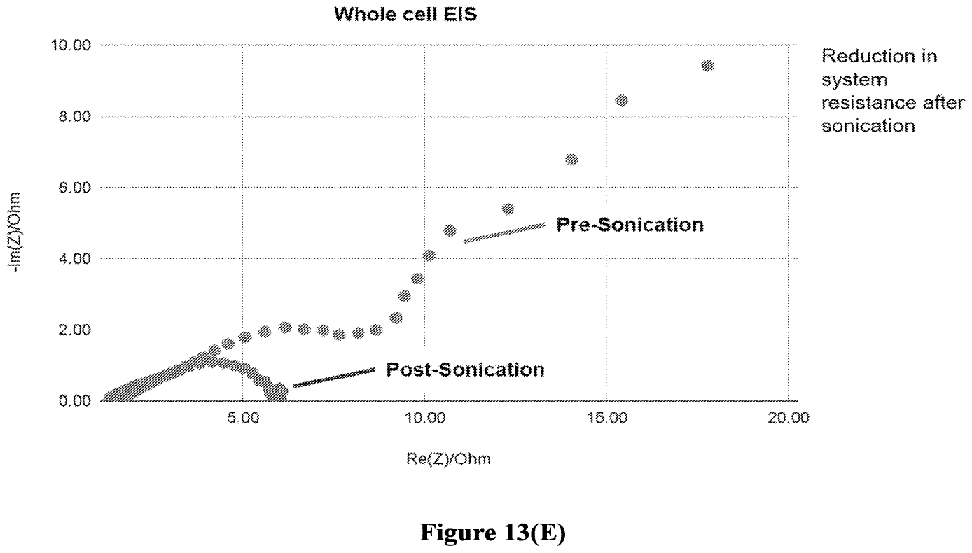

A microbial yield of −12% is possible for anaerobic biofilm growth, which can require biofilm maintenance to allow sustained performance. Without wishing to be bound by theory, we can use an electro-mechanical approach using sonication integrated with our stacks to manage excess biofilm removal at periodic intervals. FIG. 13D shows the results from the effect of excess biofilm removal via sonication in an exemplary embodiment. FIG. 13E shows the results from electrochemical impedance spectroscopy (EIS) of the MEC before and after sonication.

Research can be conducted to standardize the method and study regrowth of biofilm for sustained operation of the MEC at target productivity. The cells developed herein can be operated for 30 days to determine the rate of biofilm/biomass yield, followed by implementation of the biofilm maintenance protocol, operated in cycle for demonstrating continued operation for about 90 days.

### 3.3. Non-Limiting Example of Site-Based Demonstration of Pilot Units

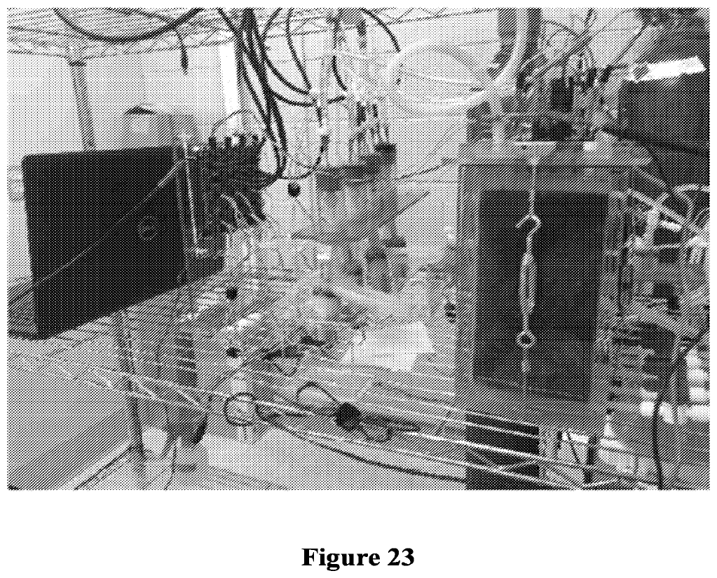

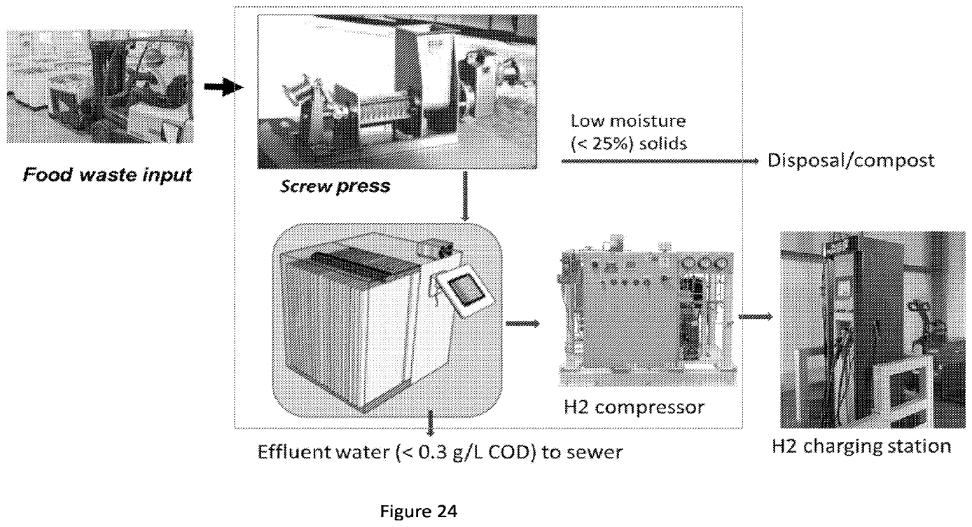

Without wishing to be bound by theory we can develop of a 1 m³ module to indicate minimum viable product. Without wishing to be bound by theory we can build various components of the system based on the existing prototype (FIG. 23) and continuing testing, getting the module. We can include interfacing with food waste sources, extracting the liquid and converting it into hydrogen, as well as utilization of the produced hydrogen, confirming both hydrogen quality and resulting emissions. The system can include a hopper to dump the waste into, a press, MEC module, and a compressor, (FIG. 24). The system can be mobile and comprise integrated front end and back-end components to convert raw food waste into 99.999% pure hydrogen.

### Example 4—Example Outline-Bioelectrochemical Process Control

### Objective

Develop and demonstrate a method for control of bioelectrochemical processes to enable commercially-relevant performance and stable operation of microbial electrolysis¹⁰ and other bioelectrochemical systems.

### Problem Statement

Current bioelectrochemical systems are operated typically under batch mode, using potentiostat or a bulky power sources to deliver the power and the control of voltage, and to monitor current and other electrochemical parameters^{1 2 3 4 5}. For industrial application of the technology, minimization of costs and size of these systems as well as establishment of a process control strategy to maintain high current density and conversion efficiency is needed. There are three problems which plague the effective generation of products such as hydrogen or other fuels and chemicals in bioelectrochemical systems.
Low current density
Insufficient charge transfer
Loss of performance over time

### Solution

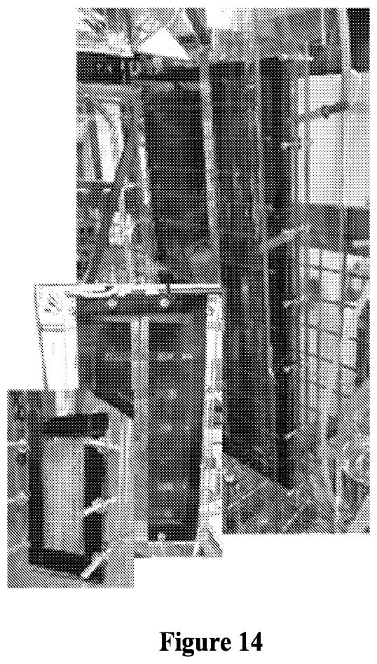

Exemplary parameters in bioelectrochemical processes include applied voltage, current density, productivity, anode Coulombic efficiency, cathode efficiency, and electrical conversion efficiency^{7 11}. FIG. 14 shows picture of exemplary devices used to generate hydrogen under presently disclosed embodiments.

### 1. High Current Density Via Bioelectrochemical Control Operated Continuously.

Electro-Active has developed a method for achieving and maintaining high hydrogen productivity (greater than 15 liters of H₂ per liter of reactor volume per day) needed for commercial feasibility as well as high production efficiency in a continuous process, by bioelectrochemical process control comprising simultaneous control of cell voltage and organic loading rate. Maintaining anode voltage between −0.3 and −0.45V, allows high current density, enabling high hydrogen productivity.

### 2. Use of Sinusoidal or Oscillating Voltage for Promoting Charge Balancing

Hydrogen production requires protons at the cathode or effective charge balancing for maintaining high hydrogen production rate. Use of sinusoidal voltage or oscillating voltage allows improved charge transfer leading to high hydrogen production rate.

### 3. Electro-Active Biofilm Maintenance for Stable, Long-Term Hydrogen Production.

Microbial biofilm growth in the anode can lead to excessive biomass in the anode, leading to problems with mass transfer, high pressure drop, byproduct generation and loss or electrons to alternate sinks, charge transfer issues, and overall loss of performance of the bioelectrochemical system. Electro-Active has developed a process to remove excess biofilms without removing the electrodes from the reactor. This can be done via a pH change of the bionode and the degradation of exopolymeric layer within the biofilm leading to detachment and removal or excess cells from the compact anode structure housing the electro-active biofilm. In embodiments, this involves subjecting the biofilm to an altered pH for a specific period of time, followed by flushing of a liquid reagent through the anode to restore high flow and high performance to the bioelectrochemical system.

### Results

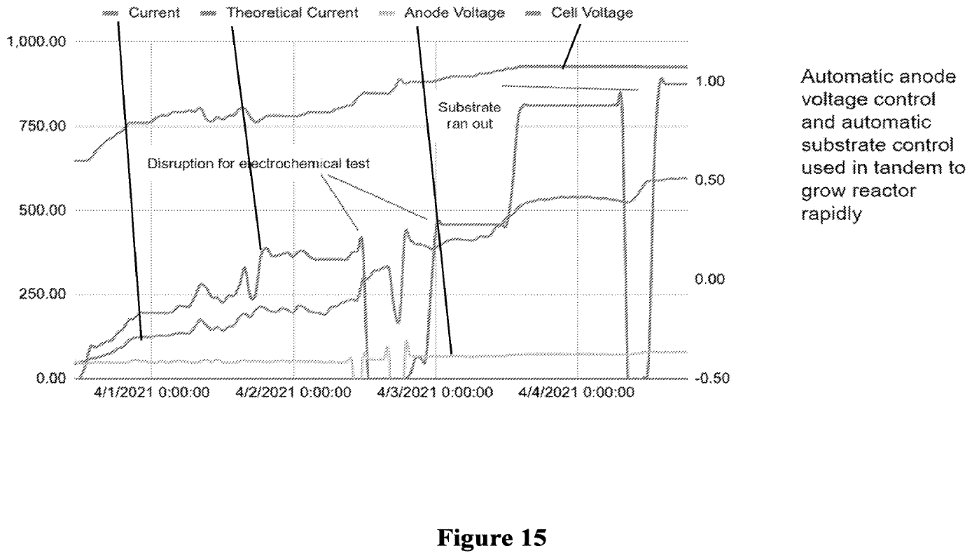

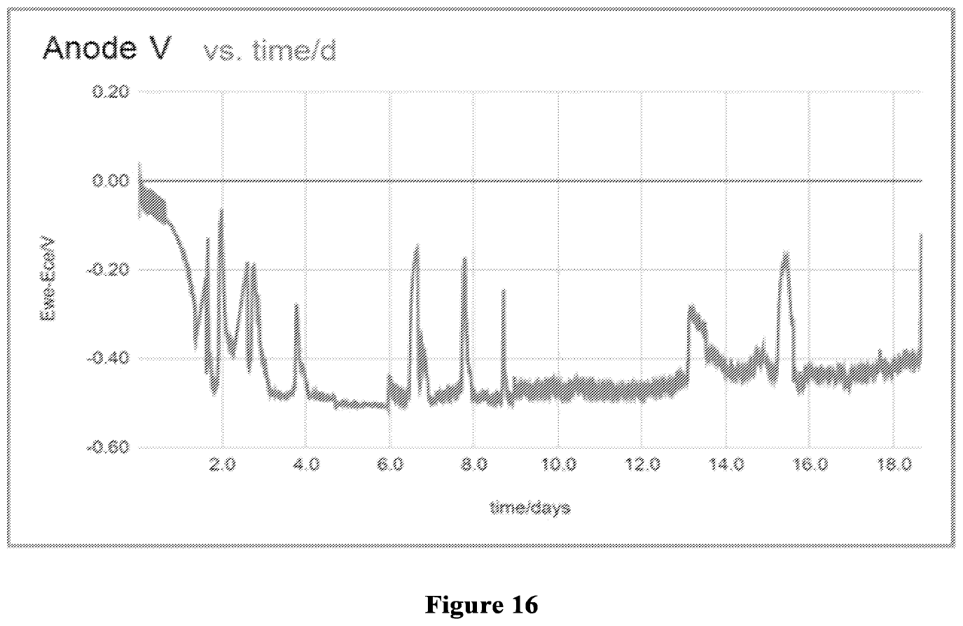

1. Use of a process control method to maintain anode voltage between −0.3 and −0.45V vs. Ag/AgCl reference electrode has resulted in achievement of high current density and hydrogen productivity and its continuous production, while enabling high conversion efficiency. A hydrogen productivity of >15 L/L-day was obtained by maintaining the anode around −0.4V and more generally in the range of −0.3 to −0.45V. This requires a certain organic loading rate to be simultaneously achieved to maintain the high current density and H₂ productivity. FIG. 15 shows the results of achieving the high current of >20 mA, corresponding to current density over 10 A/m². FIG. 16 shows the corresponding anode voltage maintained at about −0.4V or below (except for occasional spikes during change of substrate feed pump).
2. Use of oscillating or sinusoidal voltage results in alternating high and low current. This enables charge balancing leading to sustained high current density, following the oscillating or sinusoidal voltage application and a high hydrogen productivity.
3. The use of a reagent to alter pH and subsequent flushing has shown to result in a lower pressure drop through the anode. This helps maintain high mass transfer and charge transfer, leading to consistent production of hydrogen for long periods, via periodic application of this procedure.

### Conclusion

The 3 control procedures can result in 3 primary and potentially additional secondary claims via various permutations and combinations of different parameter values.

### Example 5

A method for removal of excess biofilm was developed. This can include an integrated MEC-Sonicator, to facilitate non-invasive mechanical disruption of the biofilm in the reactor itself. Two configurations of the integrated system are shown in FIG. 13. In panel A, the Sonicator can be placed at the bottom of the MEC, while in panel C, the Sonicator can be designed to be placed above the MEC anode. Panel B shows an integrated MEC-Sonicator. As a result of periodic initiation of the Sonicator, excess biofilm can be removed from the anode and removed via liquid flow from the MEC. This can allow for long-term optimal performance of the MEC, which can maintain high current over months to years.

### REFERENCES CITED HEREIN

1 Borole, A. P. et al. Efficient Conversion of Aqueous-Waste-Carbon Compounds into Electrons, Hydrogen, and Chemicals via Separations and Microbial Electrocatalysis. Frontiers in Energy Research 6, 94 (2018).
2 Zeng, X., Collins, M. A., Borole, A. P. & Pavlostathis, S. G. The extent of fermentative transformation of phenolic compounds in the bioanode controls exoelectrogenic activity in a microbial electrolysis cell. Wat. Res. 109, 299-309 (2017).
3 Zeng, X., Borole, A. P. & Pavlostathis, S. G. Inhibitory Effect of Furanic and Phenolic Compounds on Exoelectrogenesis in a Microbial Electrolysis Cell Bioanode. Environmental Science & Technology 50, 11357-11365 (2016).
4 Zeng, X. Biotransformation of Furanic and Phenolic Compounds and Hydrogen Production in Microbial Electrolysis Cells Ph.D. thesis, Georgia Institute of Technology, (2016).
5 Satinover, S. J., Schell, D. & Borole, A. P. Achieving High Hydrogen Productivities of 20 L/L-day via Microbial Electrolysis of Corn Stover Fermentation Products. Applied Energy 259, 114126 (2020).
6 Brooks, V. A. et al. Hydrogen Production from Pine-Derived Catalytic Pyrolysis Aqueous Phase via Microbial Electrolysis. Biomass & Bioenergy 119, 1-9 (2018).
7 Lewis, A. J. et al. Hydrogen production from switchgrass via a hybrid pyrolysis-microbial electrolysis process. Bior. Technol. 195, 231-241, doi: http://www.sciencedirect.com/science/article/pii/S0960852415008767 (2015).
8 Borole, A. P. Understanding Bioelectrochemical Limitations via Impedance Spectroscopy. Microbial Electrochemical Technologies, 39 (2020).
9 Borole, A. P. & Lewis, A. J. Proton transfer in microbial electrolysis cells. Sustainable Energy & Fuels 1, 725 (2017).
10 Borole, A. P. Microbial Fuel Cells and Microbial Electrolyzers. The Electrochemical Society—Interface 24, 55-59 (2015).
11 Lewis, A. J. & Borole, A. P. Understanding the impact of flow rate and recycle on the conversion of a complex biorefinery stream using a flow-through microbial electrolysis cell. Biochemical Engineering Journal 116, 95-104 (2016).

### EQUIVALENTS

Those skilled in the art will recognize, or be able to ascertain, using no more than routine experimentation, numerous equivalents to the specific substances and procedures described herein. Such equivalents are considered to be within the scope of this invention, and are covered by the following sample representative claims.

I claim:

1. A method for preparing MEC, the method comprising:
an anode, a cathode and a membrane;
establishing a biofilm on the anode while increasing the cell voltage from 0.4V to a value up to a cell voltage of 1.7V, with the cell voltage controlled by a control loop;
maintaining an anode potential at an anode voltage vs. a reference electrode potential, and
generating a desired current density of at least 1 A/m² by augmenting an organic loading rate, wherein the organic loading rate ranges in value from 0 to 100 grams of a substrate per liter of anode volume per day; and
maintaining the desired current density by varying the anode voltage, the organic loading rate, the cell voltage, or a combination thereof.

2. The method of claim 1, wherein the desired current density is at least about 5 A/m².

3. The method of claim 1, wherein the desired current density is at least about 10 A/m².

4. The method of claim 1, wherein the anode voltage comprises about −0.4V, about −0.35V, about −0.30V, about −0.25V, about −0.20V, about −0.15V, about −0.10V, about 0.05V, about 0.00V, about 0.05V, about 0.10V, about 0.15V, about 0.20V, about 0.25V, about 0.30V, about 0.35V, or about 0.40V.

5. A method to maintain a high current density in a BES of at least 1 A/m², wherein the BES comprises a microporous membrane or an ion-exchange membrane, and the method comprising:
pulsing a flow of a fluid through an anode at a frequency of 0.00001 to 10 Hz, such that periodic convective flow occurs between the anode and a cathode; and
maintaining a cathode pH at a value of less than 13.

6. The method of claim 5, where the BES membrane comprises an anion exchange membrane, and the flow of the fluid through the anode is pulsed at a frequency between 0.00001 to 10 Hz.

7. The method in claim 5 where the BES membrane comprises a cation exchange membrane, wherein the flow of the fluid through the anode is pulsed at a frequency between 0.00001 to 10 Hz.

8. The method of claim 5, wherein:
said BES is a microbial electrolysis cells (MEC); and
further comprising providing a liquid flow across said microporous membrane.

9. The method of claim 8, wherein said liquid flow goes from an anode side of said membrane to a cathode side of said membrane.

10. The method of claim 8, wherein said liquid flow comprises a pulsing liquid flow.

11. The method of claim 10, wherein said pulsing liquid flow is reversible.

12. The method of claim 8, further comprising pumping said liquid through a trap, whereby said trap provides separation of the liquid into a liquid phase and a gas phase.

13. The method of claim 12, wherein said gas phase is collected and stored as a product, and said liquid phase is pumped back to either said MEC or to an intermediate vessel and then onwards to said MEC.

14. The method of claim 8, further comprising
pumping said liquid through a device which isolates a gas phase from said liquid, leaving a remaining liquid; and
pumping said remaining liquid back to either said MEC or to an intermediate vessel and then onwards to said MEC.

15. The method of claim 1, further comprising removing excess biofilm from the MEC, wherein the step of removing excess biofilm from the MEC comprises:
passage of a low or high pH solution through the anode, cathode, or both;
sonication via an integrated MEC-sonicator;
or a combination thereof.

16. A method to maintain a low pressure drop across an anode in a BES, the method comprising:
measuring a negative pressure drop; and
if the negative pressure drop is above 1 PSI/min, removing excess biofilm to maintain the low pressure drop across the anode.

17. The method of claim 16, wherein measuring the negative pressure drop is performed with a vacuum test.

18. The method of claim 16, wherein removing excess biofilm is performed by applying a low or high pH solution or sonication.

19. The method of claim 1, further comprising creating a product, wherein the product is created during the steps of generating and maintaining the desired current.

20. The method of claim 19, wherein the product comprises hydrogen.

21. The method of claim 20, wherein the hydrogen is used for production of one or more chemical products.

22. The method of claim 19, wherein the product is a chemical derived from protons, electrons and any other added chemical.

23. A system for automated control of a BES, the BES comprising an anode, a cathode, and one or more catalysts, the system comprising:
a processor comprising means for receiving inputs from said BES and one or more ancillary measurement devices;
wherein said processor provides output to one or more control mechanisms to control one or more operation parameters of said BES;
wherein said one or more ancillary measurement devices are selected from the group comprising a voltage sensor, a current sensor, a pressure sensor, a detector for measuring organic loading rate (OLR), and a detector for measuring flow of anode fluid;
wherein said one or more control mechanisms are selected from a group comprising a power source for controlling a voltage of said anode, a device for controlling an organic loading rate (OLR), a pump for controlling a flow rate and direction of said anode fluid, a sonicator, a syringe pump operatively connected to an entry point to the chamber of said anode, and a device for controlling a flow rate of an acid or base to said BES; and
wherein said one or more operation parameters are selected from a group comprising level of biofilm buildup, pressure drop across said anode, and current density in said BES.
